(19) United States
(12) Patent Application Publication
(10) Pub. No.: US 2002/0075972 A1
(43) Pub. Date: Jun. 20, 2002

(54) Apparatus, system and method for one-of-many positions modulation in an impulse radio communications system

(75) Inventors: James L. Richards, Fayetteville, TN (US); Vernon R. Brethour, Owens Cross Roads, AL (US); Jack T. Matheney, Madison, AL (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: Time Domain Corporation

(21) Appl. No.: 09/875,290

(22) Filed: Jun. 7, 2001

Related U.S. Application Data
(63) Continuation-in-part of application No. 09/537,692, filed on Mar. 29, 2000.
(60) Provisional application No. 60/209,857, filed on Jun. 7, 2000.

(51) Int. Cl. H04L 27/14

(52) U.S. Cl. 375/324; 375/239

(57) ABSTRACT

Apparatus, systems and methods for transmitting and receiving one-of-many positions modulated impulse radio signals. An impulse radio receiver for demodulating a received impulse radio signal that is modulated according to a one-of-N positions modulation scheme, where N is the number of different possible positions where an impulse can be located within each time frame of the impulse radio signal, comprises a timing generator, one or more samplers and a data detector. The timing generator generates N timing signal, wherein each of the N timing signals is separated in time by more than ½ the width of impulses of the received impulse radio signal. The one or more samplers are triggered to sample the received impulse radio signal in accordance with the N timing signal and to provide a first to Nth sampler outputs. The data detector produces a demodulation decisions based on the first to Nth sampler outputs.

### CROSS-REFERENCE TO RELATED APPLICATIONS

The application claims priority to U.S. Provisional Patent Application No. 60/209,857, entitled “Apparatus, System and Method for One-Of-Many Positions Modulation in an Impulse Radio Communications System,” filed Jun. 7, 2000.

### BACKGROUND OF THE INVENTION

1. Field of the Invention

The present invention relates generally to apparatus, systems and methods for wireless communication. More particularly, the present invention relates to apparatus, systems and methods for modulation in an impulse radio communications system. The present invention also relates to apparatus, systems and methods for transmitting and receiving modulated impulse radio signals.

2. Background Art

The radio transmission of both analog and digital communications intelligence has normally been effected by one of two methods. In one, referred to as an amplitude modulation, a continuous sinusoidal radio frequency carrier is modulated in amplitude according to an intelligence or communications signal. When the amplitude modulated signal is received at a receiving location, the reverse process (that is, demodulation of the carrier) is effected to recover the intelligence. The other method employs what is termed frequency modulation. In frequency modulation, instead of amplitude modulation of the carrier signal, the carrier signal is frequency modulated according to the intelligence. When a frequency modulated signal is received, circuitry is employed which performs what is termed discrimination wherein changes in frequency are changed to changes in amplitude in accordance with the original modulation, and thereby a communications signal is recovered. In both systems a continuous sinusoidal carrier is assigned to and occupies a distinctive frequency bandwidth, or channel. In turn, this channel occupies spectrum space which, if interference is to be avoided, cannot be utilized by other transmissions.

Today almost every nook and cranny of spectrum space (also referred to as the frequency spectrum) is being utilized. Accordingly, there is a tremendous need for some method of expanding the availability of medium for communications. In consideration of this, new methods and systems of communications have been developed that employ a wider frequency spectrum, rather than discrete frequency channels, for radio communications links. More specifically, new methods and systems of communications have been developed that utilize wide band or ultra wide band (UWB) technology, which is also called impulse radio communications.

Impulse radio communications was first fully described in a series of patents, including U.S. Pat. Nos. 4,641,317 (issued Feb. 3, 1987), 4,813,057 (issued Mar. 14, 1989), 4,979,186 (issued Dec. 18, 1990) and 5,363,108 (issued Nov. 8, 1994) to Larry W. Fullerton. A second generation of impulse radio patents include U.S. Pat. Nos. 5,677,927 (issued Oct. 14, 1997), 5,687,169 (issued Nov. 11, 1997) and 5,832,035 (issued Nov. 3, 1998) to Fullerton et al. Each of these patent documents are incorporated herein by reference.

Basic impulse radio transmitters emit short pulses approaching a Gaussian monocycle with tightly controlled pulse-to-pulse intervals. Impulse radio systems typically use pulse position modulation (also referred to as digital time shift modulation), which is a form of time modulation where the value of each instantaneous sample of a modulating signal is caused to modulate the position of an impulse in time. More specifically, in pulse position modulation, the pulse-to-pulse interval is typically varied on a pulse-by-pulse basis by two components: a pseudo-random code component and an information component. That is, when coding is used each impulse is shifted by a coding amount, and information modulation is accomplished by shifting the coded time position by an additional amount (that is, in addition to PN code dither) in response to an information signal. This additional amount (that is, the information modulation dither) is typically very small relative to the PN code shift. For example, in a 10 mega pulse per second (Mpps) system with a center frequency of 2 GHz, the PN code may command pulse position variations over a range of 100 nsec; whereas, the information modulation may only deviate the impulse position by 150 ps (which is typically less than ½ the width of an impulse). The pulse position deviation due to information modulation modulated has been typically less than ½ the width of an impulse so that a single correlator can be used to receive the modulated impulse radio signal.

Although the above described information modulation scheme has proved effective for certain applications, there is a desire to create information modulation schemes that increase data throughput and/or decrease the probability of bit errors. Further, there is a desire to create modulation schemes that exploit the unique aspects of impulse radio communications.

### BRIEF SUMMARY OF THE INVENTION

The present invention relates to apparatus, systems and methods for modulation in an impulse radio communications system. The present invention also relates to apparatus, systems and methods for transmitting and receiving modulated impulse radio signals. According to an embodiment, the present invention is directed to transmitting and receiving one-of-many positions modulated impulse radio signals in an impulse radio communications system. One -of-many positions modulation is also referred to as one-of-N positions modulation or multiple position waveform (MPW) modulation.

According to the present invention, an impulse is placed within one of a plurality of widely separated positions within a time frame. If two widely separated positions are used within a time frame, then each position can represent one of two data states (e.g., a 0 bit, or a 1 bit). If four widely separated positions are used within a time frame, then four data states can be represented (e.g., each position can represent two bits, i.e., 00, 01, 10, or 11). If eight widely separated positions are used within a time frame, then each position can represent three bits (e.g., 000, 001, 010, 011, 100, 101, 110, or 111), and so on. The term “widely separated position” minimally means that the positions within a time frame do not overlap. In contrast, many previously disclosed time position modulation schemes dither an impulse, based on information, less than ½ the width of an impulse. For example, if an impulse width was 0.5 nsec in a previously disclosed impulse radio system, such a system may only dither each impulse approximately 150 psec based on information modulation. In the present invention, each impulse is dithered by at least ½ the impulse width, i.e., at least 0.25 nsec for this example, based on information modulation. By dithering each impulse by at least ½ the impulse width, impulse positions will not overlap (i.e., an impulse waveform received at a first position will not overlap an impulse waveform received at a second position).

Preferably, in the present invention, the dither of each impulse based on information modulation is significantly more than (e.g., by a multiple of 10) the width of the impulse. For example, where an impulse width is 0.5 nsec, each of the various positions where an impulse can be located within a time frame are preferably separated by at least 5.0 nsec. By information modulating each impulse by significantly more than the impulse width, the adverse effects of multipath reflections may be reduced. Additionally, by information modulating each impulse by significantly more than the impulse width, adverse effects of jitter (e.g., clock jitter) may also be reduce.

According to an embodiment of the present invention, an impulse radio receiver for demodulating a received impulse radio signal that is modulated according to a one-of-N positions modulation scheme, where N is the number of different possible positions where an impulse can be located within each time frame of the impulse radio signal, includes a timing generator, one or more samplers and a data detector. The timing generator generates N timing signals, wherein each of the N timing signals is separated in time by more than ½ the width of received impulses of the received impulse radio signal. The one or more samplers are triggered to sample the received impulse radio signal in accordance with the N timing signals and to provide a first to Nth sampler outputs. The data detector produces one or more demodulation decisions based on the first to Nth sampler outputs.

According to another embodiment of the present invention, a receiver includes an adjustable precision timing generator, a data correlator, a threshold comparitor, a data sample and hold, a counter, a latch and a data detector. The adjustable precision timing generator generates N timing signals, wherein each of the N timing signals is separated in time from one other by more than ½ the width of received impulses of the received impulse radio signal. The data correlator samples the received impulse radio signal in accordance with the N timing signals to provide a first sampler output through an Nth sampler output. The threshold comparitor compares each of the first sampler output through the Nth sampler output to a threshold and outputs a threshold trigger signal when the threshold is exceeded. The data sample and hold (S/H) samples at least one of the first sampler output through the Nth sampler output in response to the threshold trigger signal and outputs one or more corresponding sample values that exceed the threshold. The counter increments a count value in response to receiving each of the N timing outputs, and resets every N timing outputs. The latch stores the count value in response to the threshold trigger signal. The data detector produces a demodulation decision based on at least the count value received from the latch and the corresponding sample value.

Impulse radios have typically been resistant to the effects of delayed multipath reflections. This is because delayed multipath reflections typically arrive outside the correlation time and thus have generally been ignored. However, this is not necessarily the case when receiving impulses that have been modulated using a one-of-many positions modulation scheme. Rather, in a one-of-many positions modulation scheme, it is very probable that delayed multipath reflections associated with an impulse placed in a first location will arrive during the correlation times (also referred to as sampling times) of downstream correlations (also referred to as downstream samples). Delayed multipath reflections are one example of what is referred to collectively as ringing or downstream artifacts, which are those signal attributes associated with an impulse that are located later in time than (i.e., downstream from) the intended (or expected) waveform of a received impulse. In addition to delayed multipath reflections, ringing can be caused by a number of other things, such as by components within an impulse radio transmitter and/or by components within an impulse radio receiver.

This ringing can cause demodulation decision errors if the ringing plus noise is greater than the signal (i.e., impulse) plus noise. For example, a receiver used in a one-of-four positions modulation scheme samples a received signal at least four times per frame in an attempt to determine which data state was received. If the sample value (i.e., correlation output) associated with a downstream artifact plus noise (e.g., a sample taken at the second position of the four positions) is greater than the sample value of the actual impulse plus noise (e.g., taken at the first position), then the receiver can make a wrong demodulation decision regarding which data state (also referred to as, symbol) is associated with the frame of the receive signal. A feature of the present invention is the use these downstream artifacts to increase the confidence of demodulation decisions. Another feature of the present invention is to adjust the downstream positions (e.,g., the second, third and fourth positions) used during transmission of impulses and to correspondingly adjust the downstream sampling positions used during reception of impulses, so that the disruptive effects of downstream artifacts are reduced. A further feature of the present invention is to combine the above features such that downstream positions are adjusted to maximize the confidence of demodulation decisions that include consideration of downstream artifact measurements.

The use of downstream artifacts is very useful in environments where ringing (i.e., downstream artifacts) remains somewhat constant over periods of time. However, if the knowledge learned from earlier received signals is no longer relevant to the later received signals, use of such knowledge can actual corrupt demodulation decisions rather than improve them. This can occur, for example, in environments having constant motion (e.g., movement of a fan blade or the like). Accordingly, in another embodiment of the present invention, the locations of downstream positions are shifted (i.e., adjusted) according to a pattern known by both a transmitter and a receiver. An advantage of this embodiment is that it can improve demodulation decisions made by receivers that are in environments where downstream artifacts unacceptably corrupt demodulation decisions. This is because the shifting of downstream locations breaks up the effects of downstream artifacts.

Further features and advantages of the present invention, as well as the structure and operation of various embodiments of the present invention, are described in detail below with reference to the accompanying drawings.

### BRIEF DESCRIPTION OF THE DRAWINGS/FIGURES

Within the accompanying drawings, the convention used to describe signal connections requires that a signal line end at a junction with another signal line to indicate a connection. Two signal lines that cross indicate no connection at the crossing. The present invention is described with reference to the accompanying drawings, wherein:

FIG. 1A illustrates a representative Gaussian Monocycle waveform in the time domain.

FIG. 1B illustrates the frequency domain amplitude of the Gaussian Monocycle of FIG. 1A.

FIG. 2A illustrates an impulse train comprising pulses as in FIG. 1A.

FIG. 2B illustrates the frequency domain amplitude of the waveform of FIG. 2A.

FIG. 3 illustrates the frequency domain amplitude of a sequence of time coded pulses.

FIG. 4 illustrates a typical received signal and interference signal.

FIG. 5A illustrates a typical geometrical configuration giving rise to multipath received signals.

FIG. 5B illustrates exemplary multipath signals in the time domain.

FIGS. 5C-5E illustrate a signal plot of various multipath environments.

FIG. 5F illustrates the Rayleigh fading curve associated with non-impulse radio transmission in a multipath environment.

FIG. 5G illustrates a plurality of multipaths with a plurality of reflectors from a transmitter to a receiver.

FIG. 5H graphically represents signal strength as volts vs. time in a direct path and multipath environment.

FIG. 6 is a functional diagram of an exemplary ultra wide band impulse radio transmitter.

FIG. 7 is a functional diagram of an exemplary ultra wide band impulse radio receiver.

FIG. 8A illustrates a representative received pulse signal at the input to the correlator.

FIG. 8B illustrates a sequence of representative impulse signals in the correlation process.

FIG. 8C illustrates the potential locus of results as a function of the various potential template time positions.

FIG. 9 illustrates signal waveforms that are useful in explaining a modulation scheme according to an embodiment of the present invention.

FIG. 10 is a functional diagram of an impulse radio receiver, according to an embodiment of the present invention.

FIGS. 11A and 11B illustrate correlation functions associated with the receiver of FIG. 10.

FIG. 12 is a functional diagram of the max value selector of the receiver of FIG. 10, according to an embodiment of the present invention.

FIGS. 13A and 13B illustrate signal waveforms that are useful in explaining an example of subcarrier modulation.

FIG. 14 is a functional diagram of an impulse radio receiver, according to an alternative embodiment of the present invention.

FIG. 15 illustrates signal waveforms that are useful in explaining a one-of four-positions modulation scheme, according to an embodiment of the present invention.

FIG. 16 is a functional diagram of an impulse radio receiver, according to an embodiment of the present invention.

FIGS. 17A and 17B illustrate signal waveforms that are useful in explaining subcarrier modulation.

FIG. 18 is a functional diagram of an impulse radio receiver, according to another embodiment of the present invention.

FIGS. 19 and 20 are functional diagrams of data detectors used in the receiver of FIG. 18, according to embodiments of the present invention.

FIG. 21 illustrates four possible positions that an impulse may be located in received signal that was modulated using a one-of-four positions modulation scheme.

FIG. 22 shows an example of correlator output associated with the receiver of FIG. 18.

FIGS. 23A-23D illustrate waveforms that are useful for explaining downstream artifacts that are used during demodulation decisions in an embodiment of the present invention.

FIG. 24 illustrates an example of an artifact table for use in a receiver that receives one-of-four-positions modulated signals.

FIGS. 25A and 25B illustrate possible positions that an impulse may be located in two different frames of a received signal that was modulated using a one-of-four positions modulation scheme where downstream positions are shifted, according to an embodiment of the present invention.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### Table of Contents

I. Overview of the Invention

II. Impulse Radio Basics

II.1. Waveforms

II.2. Impulse Trains

II.3. Coding for Energy Smoothing and Channelization

II.4. Modulation

II.5 Reception and Demodulation

II.6. Interference Resistance

II.7. Processing Gain

II.8. Capacity

II.9. Multipath and Propagation

II.10. Distance Measurement

II.11. Exemplary Transceiver

II.12 Exemplary Receiver

III. Preferred Embodiments

III.1. One-of-Many positions Modulation

III.1.A. Transmitter

III.1.B. Receiver

III.1.B.i. Correlation Process

III.1.B.ii. Max Value Selector

III.1.B.iii. Illustrative Examples

III.1.B.iv. Lock Loop Function

III.1.C. Use of a Subcarrier

III.2. Alternative Embodiments

III.2.A. Single Correlator Embodiment

III.2.B. One-of-Four Positions Modulation

III.2.C. Use of Threshold Comparison

III.3. Use of Artifacts During Demodulation.

III.3.A. Use of Artifacts to Increase Confidence of a Decision

III.3.B. Use of Artifacts to Adjust Downstream Positions of Impulses

III.4.C. Adjust Positions of Impulses to Reduce Effects of Artifacts

IV. M-of-N Positions Modulation

V. One-of-Many Positions with Shift Modulation

VI. One-of-Many Positions with Shift Modulation

VII. One-of-Many Positions with Amplitude Modulation

VIII. Combining Embodiments

IX. Conclusion

### DETAILED DESCRIPTION OF THE INVENTION

I. Overview of the Invention

The present invention relates to new types of modulation schemes for use in impulse radio communications systems. Additionally, the present invention relates to the transmitters and receivers that can be used to transmit and receive signals that have been modulated using these new types of modulation schemes.

In the present invention, what shall be referred to as “one-of-many positions” modulation is used. In a “one-of-two-positions” modulation scheme, a first data state corresponds to a first position in time of an impulse signal and a second data state corresponds to a second position in time of an impulse signal. In another embodiment, two additional data states are created using third and fourth position is time (i.e., in a “one-of-four positions” modulation scheme). Of course the teachings of the present invention can be used to develop modulation schemes that include even more data states, while still being within the spirit and scope of the present invention.

The modulation schemes of the present invention provide for increased data speeds in impulse radio communications systems because they enable additional date states to be represented by an impulse or impulse train. Additionally, the modulation schemes of the present invention provide for increased signal to noise ratio and decreased bit error rates over conventional impulse radio modulation schemes.

The present invention builds upon existing impulse radio techniques. Accordingly, an overview of impulse radio basics is provided prior to a discussion of the specific embodiments of the present invention. This overview is useful for understanding the present invention.

II. Impulse Radio Basics

This section is directed to technology basics and provides the reader with an introduction to impulse radio concepts, as well as other relevant aspects of communications theory. This section includes subsections relating to waveforms, impulse trains, coding for energy smoothing and channelization, modulation, reception and demodulation, interference resistance, processing gain, capacity, multipath and propagation, distance measurement, and qualitative and quantitative characteristics of these concepts. It should be understood that this section is provided to assist the reader with understanding the present invention, and should not be used to limit the scope of the present invention.

Impulse radio refers to a radio system based on short, low duty cycle pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Most waveforms with enough bandwidth approximate a Gaussian shape to a useful degree.

Impulse radio can use many types of modulation, including AM, time shift (also referred to as pulse position) and M-ary versions. The time shift method has simplicity and power output advantages that make it desirable. In this document, the time shift method is used as an illustrative example.

In impulse radio communications, the pulse-to-pulse interval can be varied on a pulse-by-pulse basis by two components: an information component and a pseudo-random code component. Generally, conventional spread spectrum systems make use of pseudo-random codes to spread the normally narrow band information signal over a relatively wide band of frequencies. A conventional spread spectrum receiver correlates these signals to retrieve the original information signal. Unlike conventional spread spectrum systems, the pseudo-random code for impulse radio communications is not necessary for energy spreading because the monocycle pulses themselves have an inherently wide bandwidth. Instead, the pseudo-random code is used for channelization, energy smoothing in the frequency domain, resistance to interference, and reducing the interference potential to nearby receivers.

The impulse radio receiver is typically a direct conversion receiver with a cross correlator front end in which the front end coherently converts an electromagnetic impulse train of monocycle pulses to a baseband signal in a single stage. The baseband signal is the basic information signal for the impulse radio communications system. It is often found desirable to include a subcarrier with the baseband signal to help reduce the effects of amplifier drift and low frequency noise. The subcarrier that is typically implemented alternately reverses modulation according to a known pattern at a rate faster than the data rate. This same pattern is then used to reverse the process and restore the original data pattern just before detection. This method permits alternating current (AC) coupling of stages, or equivalent signal processing to eliminate direct current (DC) drift and errors from the detection process. This method is described in detail in U.S. Pat. No. 5,677,927 to Fullerton et al.

In impulse radio communications utilizing time shift modulation, each data bit typically time position modulates many pulses of the periodic timing signal. This yields a modulated, coded timing signal that comprises a train of identically shaped pulses for each single data bit. The impulse radio receiver integrates multiple pulses to recover the transmitted information.

II.1. Waveforms

Impulse radio refers to a radio system based on short, low duty cycle pulses. In the widest bandwidth embodiment, the resulting waveform approaches one cycle per impulse at the center frequency. In more narrow band embodiments, each impulse consists of a burst of cycles usually with some spectral shaping to control the bandwidth to meet desired properties such as out of band emissions or in-band spectral flatness, or time domain peak power or burst off time attenuation.

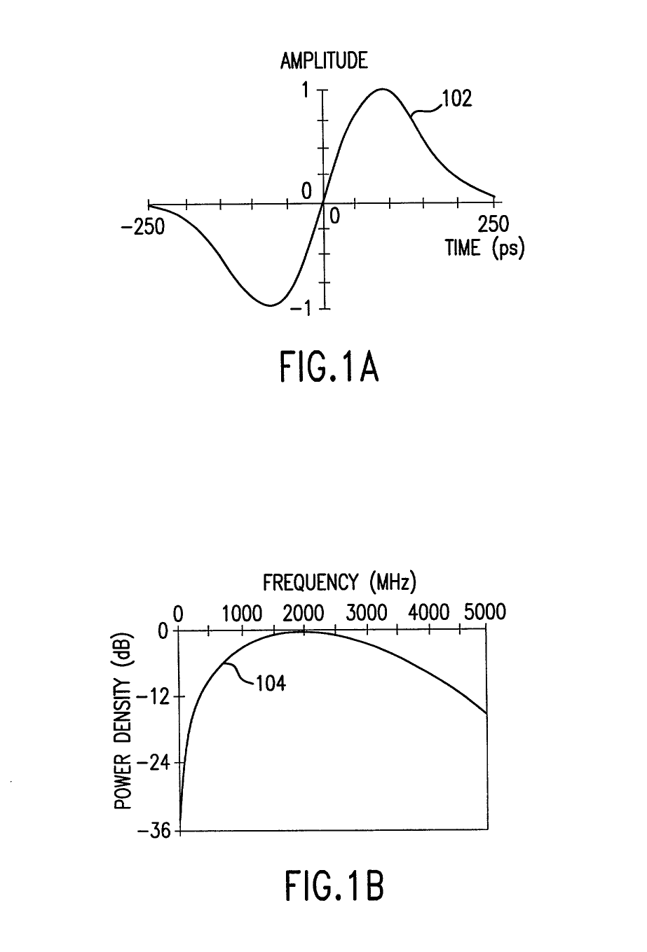

For system analysis purposes, it is convenient to model the desired waveform in an ideal sense to provide insight into the optimum behavior for detail design guidance. One such waveform model that has been useful is the Gaussian monocycle as shown in FIG. 1A. This waveform is representative of the transmitted impulse produced by a step function into an ultra-wideband antenna. The basic equation normalized to a peak value of 1 is as follows:

$${f}_{mono} ( t ) = \sqrt{e} ( \frac{t}{σ} ) {ⅇ}^{\frac{- {t}^{2}}{2 {σ}^{2}}}$$

Where,

σ is a time scaling parameter,

t is time,

ƒₘₒₙₒ(t) is the waveform voltage, and

e is the natural logarithm base.

The frequency domain spectrum of the above waveform is shown in FIG. 1B. The corresponding equation is:

$${F}_{mono} ( f ) = {( 2 π )}^{\frac{3}{2}} σ f {ⅇ}^{- 2 {( πσ f )}^{2}}$$

The center frequency (ƒ_{c}), or frequency of peak spectral density is:

$${f}_{c} = \frac{1}{2 π σ}$$

These pulses, or bursts of cycles, may be produced by methods described in the patents referenced above or by other methods that are known to one of ordinary skill in the art. Any practical implementation will deviate from the ideal mathematical model by some amount. In fact, this deviation from ideal may be substantial and yet yield a system with acceptable performance. This is especially true for microwave implementations, where precise waveform shaping is difficult to achieve. These mathematical models are provided as an aid to describing ideal operation and are not intended to limit the invention. In fact, any burst of cycles that adequately fills a given bandwidth and has an adequate on-off attenuation ratio for a given application will serve the purpose of this invention.

II.2. Impulse Trains

Impulse radio systems can deliver one or more data bits per impulse; however, impulse radio systems more typically use impulse trains, not single pulses, for each data bit. As described in detail in the following example system, the impulse radio transmitter produces and outputs a train of pulses for each bit of information.

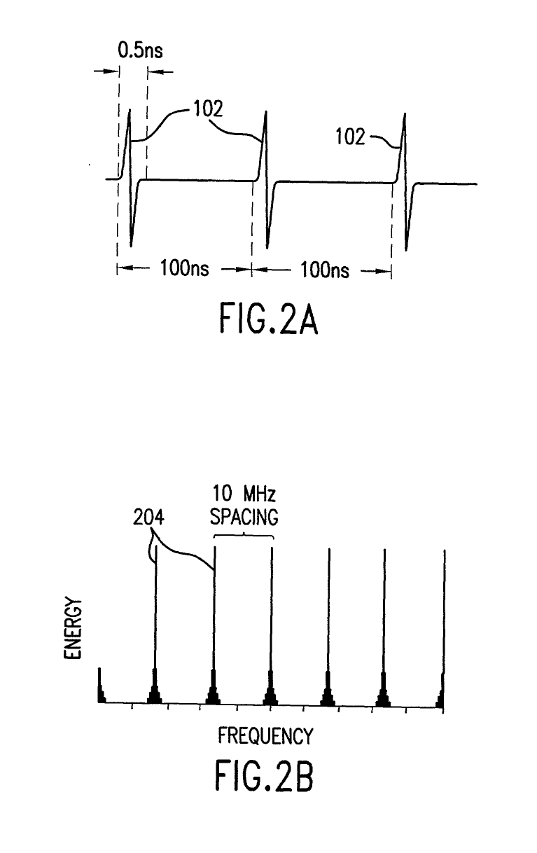

Prototypes built by the inventors have impulse repetition frequencies including 0.7 and 10 megapulse per second (Mpps, where each megapulse is 10⁶ pulses). FIGS. 2A and 2B are illustrations of the output of a typical 10 Mpps system with uncoded, unmodulated, 0.5 nanosecond (nsec) pulses 102. FIG. 2A shows a time domain representation of this sequence of pulses 102. FIG. 2B, which shows 60 MHz at the center of the spectrum for the waveform of FIG. 2A, illustrates that the result of the impulse train in the frequency domain is to produce a spectrum comprising a set of comb lines 204 spaced at the frequency of the 10 Mpps pulse repetition rate. When the full spectrum is shown, the envelope of the line spectrum follows the curve of the single impulse spectrum 104 of FIG. 1B. For this simple uncoded case, the power of the impulse train is spread among roughly two hundred comb lines. Each comb line thus has a small fraction of the total power and presents much less of an interference problem to receiver sharing the band.

It can also be observed from FIG. 2A that impulse radio systems typically have very low average duty cycles resulting in average power significantly lower than peak power. The duty cycle of the signal in the present example is 0.5%, based on a 0.5 nsec impulse in a 100 nsec interval.

II.3. Coding for Energy Smoothing and Channelization

For high pulse rate systems, it may be necessary to more finely spread the spectrum than is achieved by producing comb lines. This may be done by pseudo-randomly positioning each impulse relative to its nominal position.

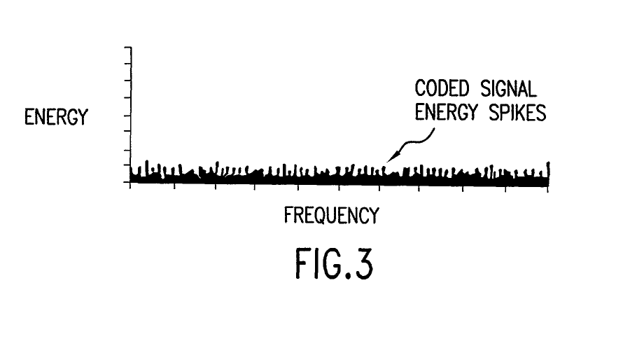

FIG. 3 is a plot illustrating the impact of a pseudo-noise (PN) code dither on energy distribution in the frequency domain (A pseudo-noise, or PN code is a set of time positions defining the pseudo-random positioning for each impulse in a sequence of pulses). FIG. 3, when compared to FIG. 2B, shows that the impact of using a PN code is to destroy the comb line structure and spread the energy more uniformly. This structure typically has slight variations which are characteristic of the specific code used.

The PN code also provides a method of establishing independent communication channels using impulse radio. PN codes can be designed to have low cross correlation such that an impulse train using one code will seldom collide on more than one or two impulse positions with an impulse train using another code during any one data bit time. Since a data bit may comprise hundreds of pulses, this represents a substantial attenuation of the unwanted channel.

II.4. Modulation

Any aspect of the waveform can be modulated to convey information. Amplitude modulation, phase modulation, frequency modulation, time shift modulation and M-ary versions of these have been proposed. Both analog and digital forms have been implemented. Of these, digital time shift modulation has been demonstrated to have various advantages and can be easily implemented using a correlation receiver architecture.

Digital time shift modulation can be implemented by shifting the coded time position by an additional amount (that is, in addition to PN code dither) in response to the information signal. This amount is typically very small relative to the PN code shift. In a 10 Mpps system with a center frequency of 2 GHz., for example, the PN code may command pulse position variations over a range of 100 nsec; whereas, the information modulation may only deviate the impulse position by 150 ps.

Thus, in an impulse train of n pulses, each impulse is delayed a different amount from its respective time base clock position by an individual code delay amount plus a modulation amount, where n is the number of pulses associated with a given data symbol digital bit.

Modulation further smooths the spectrum, minimizing structure in the resulting spectrum.

II.5. Reception and Demodulation

Clearly, if there were a large number of impulse radio users within a confined area, there might be mutual interference. Further, while the PN coding minimizes that interference, as the number of users rises, the probability of an individual impulse from one user's sequence being received simultaneously with an impulse from another user's sequence increases. Impulse radios are able to perform in these environments, in part, because they do not depend on receiving every impulse. The impulse radio receiver performs a correlating, synchronous receiving function (at the RF level) that uses a statistical sampling and combining of many pulses to recover the transmitted information.

Impulse radio receivers typically integrate from 1 to 1000 or more pulses to yield the demodulated output. The optimal number of pulses over which the receiver integrates is dependent on a number of variables, including impulse rate, bit rate, interference levels, and range.

II.6. Interference Resistance

Besides channelization and energy smoothing, the PN coding also makes impulse radios highly resistant to interference from all radio communications systems, including other impulse radio transmitters. This is critical as any other signals within the band occupied by an impulse signal potentially interfere with the impulse radio. Since there are currently no unallocated bands available for impulse systems, they must share spectrum with other conventional radio systems without being adversely affected. The PN code helps impulse systems discriminate between the intended impulse transmission and interfering transmissions from others.

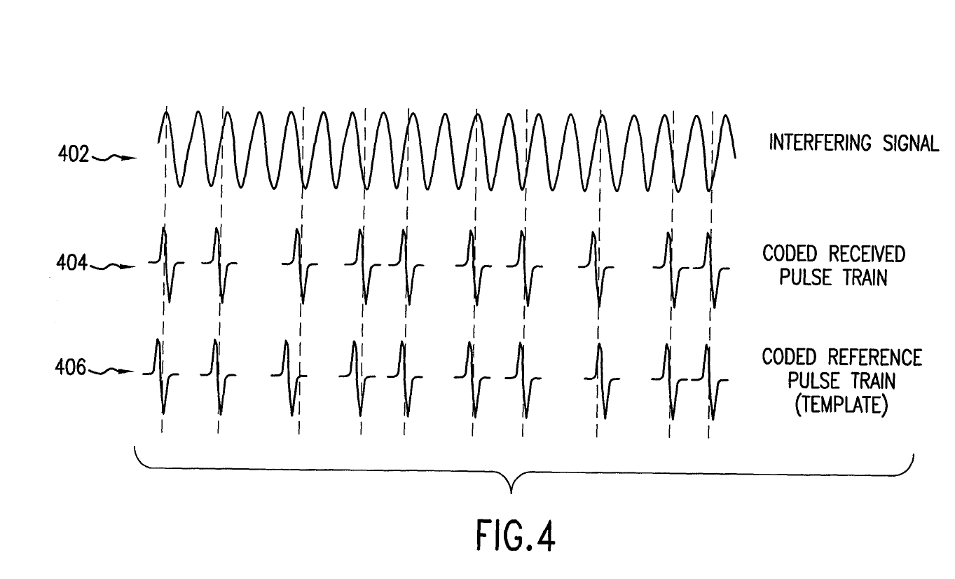

FIG. 4 illustrates the result of a narrow band sinusoidal interference signal 402 overlaying an impulse radio signal 404. At the impulse radio receiver, the input to the cross correlation would include the narrow band signal 402, as well as the received ultrawide-band impulse radio signal 404. The input is sampled by the cross correlator with a PN dithered template signal 406. Without PN coding, the cross correlation would sample the interfering signal 402 with such regularity that the interfering signals could cause significant interference to the impulse radio receiver. However, when the transmitted impulse signal is encoded with the PN code dither (and the impulse radio receiver template signal 406 is synchronized with that identical PN code dither) the correlation samples the interfering signals pseudo-randomly. The samples from the interfering signal add incoherently, increasing roughly according to square root of the number of samples integrated; whereas, the impulse radio samples add coherently, increasing directly according to the number of samples integrated. Thus, integrating over many pulses overcomes the impact of interference.

II.7. Processing Gain

Impulse radio is resistant to interference because of its large processing gain. For typical spread spectrum systems, the definition of processing gain, which quantifies the decrease in channel interference when wide-band communications are used, is the ratio of the bandwidth of the channel to the bit rate of the information signal. For example, a direct sequence spread spectrum system with a 10 kHz information bandwidth and a 10 MHz channel bandwidth yields a processing gain of 1000 or 30 dB. However, far greater processing gains are achieved with impulse radio systems, where for the same 10 kHz information bandwidth is spread across a much greater 2 GHz channel bandwidth, the theoretical processing gain is 200,000 or 53 dB.

II.8. Capacity

It has been shown theoretically, using signal to noise arguments, that thousands of simultaneous voice channels are available to an impulse radio system as a result of the exceptional processing gain, which is due to the exceptionally wide spreading bandwidth.

For a simplistic user distribution, with N interfering users of equal power equidistant from the receiver, the total interference signal to noise ratio as a result of these other users can be described by the following equation:

$${V}_{tot}^{2} = \frac{N {σ}^{2}}{\sqrt{Z}}$$

Where,

V²ₜₒₜ is the total interference signal to noise ratio variance, at the receiver,

N is the number of interfering users,

σ² is the signal to noise ratio variance resulting from one of the interfering signals with a single impulse cross correlation, and

Z is the number of pulses over which the receiver integrates to recover the modulation.

This relationship suggests that link quality degrades gradually as the number of simultaneous users increases. It also shows the advantage of integration gain. The number of users that can be supported at the same interference level increases by the square root of the number of pulses integrated.

II.9. Multipath and Propagation

One of the striking advantages of impulse radio is its resistance to multipath fading effects. Conventional narrow band systems are subject to multipath through the Rayleigh fading process, where the signals from many delayed reflections combine at the receiver antenna according to their seemingly random relative phases. This results in possible summation or possible cancellation, depending on the specific propagation to a given location. This situation occurs where the direct path signal is weak relative to the multipath signals, which represents a major portion of the potential coverage of a radio system. In mobile systems, this results in wild signal strength fluctuations as a function of distance traveled, where the changing mix of multipath signals results in signal strength fluctuations for every few feet of travel.

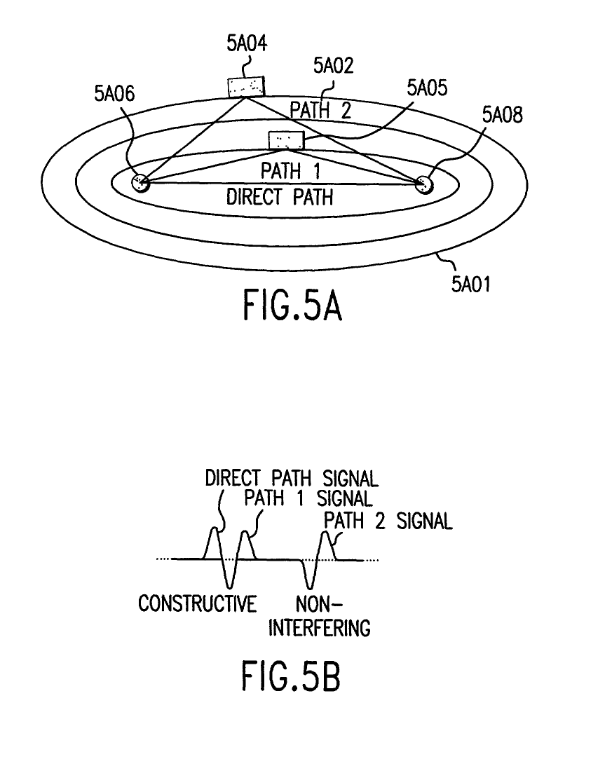

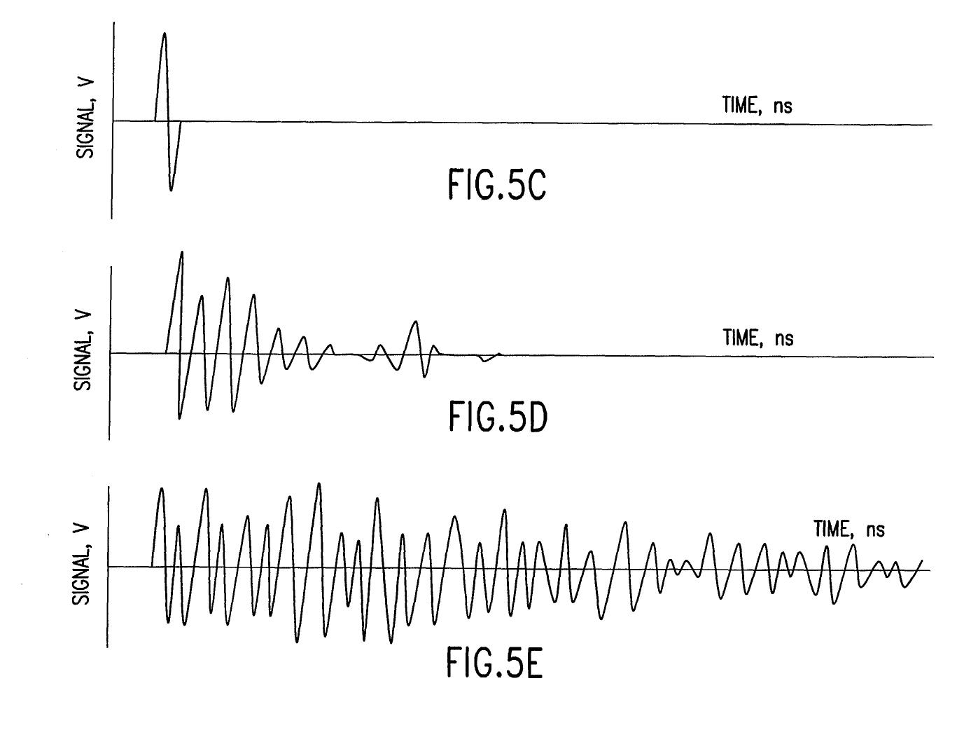

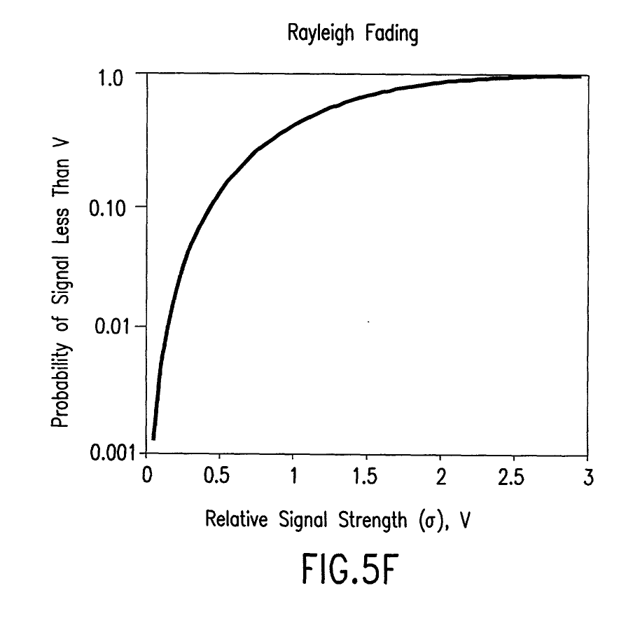

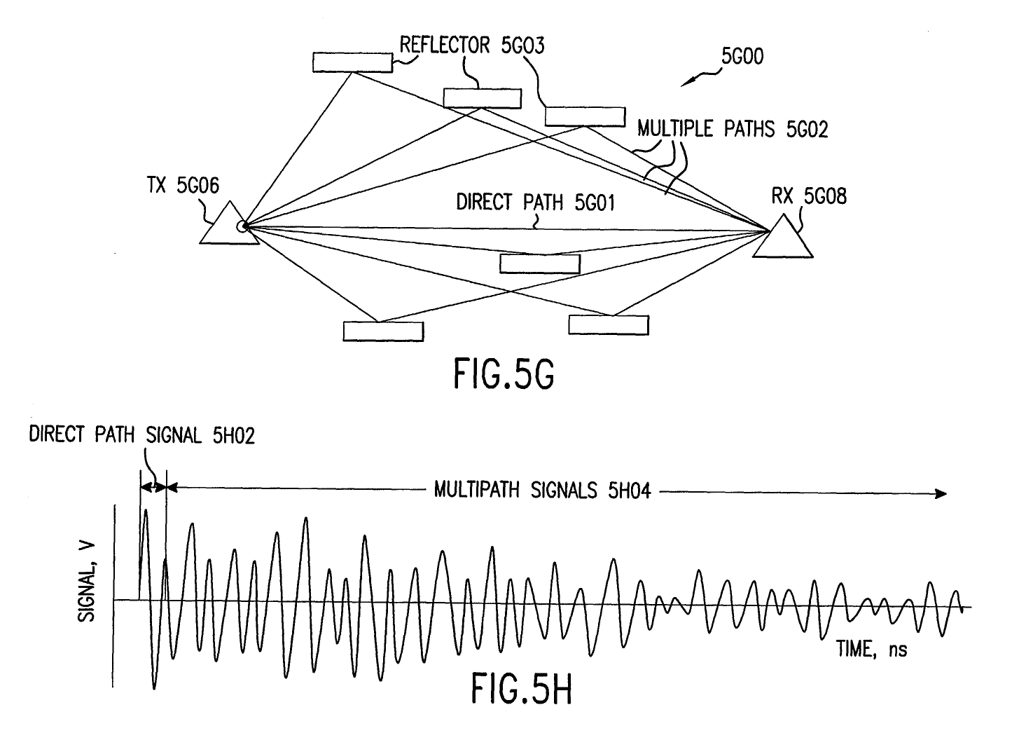

Impulse radios, however, can be substantially resistant to these effects. Impulses arriving from delayed multipath reflections typically arrive outside of the correlation time and thus can be ignored. This process is described in detail with reference to FIGS. 5A and 5B. In FIG. 5A, three propagation paths are shown. The direct path representing the straight line distance between the transmitter and receiver is the shortest. Path 1 represents a grazing multipath reflection, which is very close to the direct path. Path 2 represents a distant multipath reflection. Also shown are elliptical (or, in space, ellipsoidal) traces that represent other possible locations for reflections with the same time delay.

FIG. 5B represents a time domain plot of the received waveform from this multipath propagation configuration. This figure comprises three doublet pulses as shown in FIG. 1A. The direct path signal is the reference signal and represents the shortest propagation time. The path 1 signal is delayed slightly and actually overlaps and enhances the signal strength at this delay value. Note that the reflected waves are reversed in polarity. The path 2 signal is delayed sufficiently that the waveform is completely separated from the direct path signal. If the correlator template signal is positioned at the direct path signal, the path 2 signal will produce no response. It can be seen that only the multipath signals resulting from very close reflectors have any effect on the reception of the direct path signal. The multipath signals delayed less than one quarter wave (one quarter wave is about 1.5 inches, or 3.5 cm at 2 GHz center frequency) are the only multipath signals that can attenuate the direct path signal. This region is equivalent to the first Fresnel zone familiar to narrow band systems designers. Impulse radio, however, has no further nulls in the higher Fresnel zones. The ability to avoid the highly variable attenuation from multipath gives impulse radio significant performance advantages.

FIG. 5A illustrates a typical multipath situation, such as in a building, where there are many reflectors 5A04, 5A05 and multiple propagation paths 5A02, 5A01. In this figure, a transmitter TX 5A06 transmits a signal which propagates along the multiple propagation paths 5A02, 5A04 to receiver RX 5A08, where the multiple reflected signals are combined at the antenna.

FIG. 5B illustrates a resulting typical received composite pulse waveform resulting from the multiple reflections and multiple propagation paths 5A01, 5A02. In this figure, the direct path signal 5A01 is shown as the first pulse signal received. The multiple reflected signals (“multipath signals”, or “multipath”) comprise the remaining response as illustrated.

FIGS. 5C, 5D, and 5E represent the received signal from a TM-UWB transmitter in three different multipath environments. These figures are not actual signal plots, but are hand drawn plots approximating typical signal plots. FIG. 5C illustrates the received signal in a very low multipath environment. This may occur in a building where the receiver antenna is in the middle of a room and is one meter from the transmitter. This may also represent signals received from some distance, such as 100 meters, in an open field where there are no objects to produce reflections. In this situation, the predominant pulse is the first received pulse and the multipath reflections are too weak to be significant. FIG. 5D illustrates an intermediate multipath environment. This approximates the response from one room to the next in a building. The amplitude of the direct path signal is less than in FIG. 5C and several reflected signals are of significant amplitude. (Note that the scale has been increased to normalize the plot.) FIG. 5E approximates the response in a severe multipath environment such as: propagation through many rooms; from corner to corner in a building; within a metal cargo hold of a ship; within a metal truck trailer; or within an intermodal shipping container. In this scenario, the main path signal is weaker than in FIG. 5D. (Note that the scale has been increased again to normalize the plot.) In this situation, the direct path signal power is small relative to the total signal power from the reflections.

An impulse radio receiver in accordance with the present invention can receive the signal and demodulate the information using either the direct path signal or any multipath signal peak having sufficient signal to noise ratio. Thus, the impulse radio receiver can select the strongest response from among the many arriving signals. In order for the signals to cancel and produce a null at a given location, dozens of reflections would have to be cancelled simultaneously and precisely while blocking the direct path—a highly unlikely scenario. This time separation of multipath signals together with time resolution and selection by the receiver permit a type of time diversity that virtually eliminates cancellation of the signal. In a multiple correlator rake receiver, performance is further improved by collecting the signal power from multiple signal peaks for additional signal to noise performance.

Where the system of FIG. 5A is a narrow band system and the delays are small relative to the data bit time, the received signal is a sum of a large number of sine waves of random amplitude and phase. In the idealized limit, the resulting envelope amplitude has been shown to follow a Rayleigh probability distribution as follows:

$$p ( r ) = \frac{1}{{σ}^{2}} exp ( \frac{- {r}^{2}}{2 {σ}^{2}} )$$

where r is the envelope amplitude of the combined multipath signals, and 2s 2 is the RMS power of the combined multipath signals.

This distribution shown in FIG. 5F. It can be seen in FIG. 5F that 10% of the time, the signal is more than 16 dB attenuated. This suggests that 16 dB fade margin is needed to provide 90% link availability. Values of fade margin from 10 to 40 dB have been suggested for various narrow band systems, depending on the required reliability. This characteristic has been the subject of much research and can be partially improved by such techniques as antenna and frequency diversity, but these techniques result in additional complexity and cost.

In a high multipath environment such as inside homes, offices, warehouses, automobiles, trailers, shipping containers, or outside in the urban canyon or other situations where the propagation is such that the received signal is primarily scattered energy, impulse radio, according to the present invention, can avoid the Rayleigh fading mechanism that limits performance of narrow band systems. This is illustrated in FIG. 5G and 5H in a transmit and receive system in a high multipath environment 5G00, wherein the transmitter 5G06 transmits to receiver 5G08 with the signals reflecting off reflectors 5G03 which form multipaths 5G02. The direct path is illustrated as 5G01 with the signal graphically illustrated at 5H02, with the vertical axis being the signal strength in volts and horizontal axis representing time in nanoseconds. Multipath signals are graphically illustrated at 5H04.

II.10. Distance Measurement

Impulse systems can measure distances to extremely fine resolution because of the absence of ambiguous cycles in the waveform. Narrow band systems, on the other hand, are limited to the modulation envelope and cannot easily distinguish precisely which RF cycle is associated with each data bit because the cycle-to-cycle amplitude differences are so small they are masked by link or system noise. Since the impulse radio waveform has no multi-cycle ambiguity, this allows positive determination of the waveform position to less than a wavelength—potentially, down to the noise floor of the system. This time position measurement can be used to measure propagation delay to determine link distance, and once link distance is known, to transfer a time reference to an equivalently high degree of precision. The inventors of the present invention have built systems that have shown the potential for centimeter distance resolution, which is equivalent to about 30 ps of time transfer resolution. See, for example, commonly owned, co-pending application Nos. 09/045,929, filed Mar. 23, 1998, titled “Ultrawide-Band Position Determination System and Method”, and 09/083,993, filed May 26, 1998, titled “System and Method for Distance Measurement by In phase and Citriodora Signals in a Radio System”, both of which are incorporated herein by reference.

II.11. Exemplary Transmitter

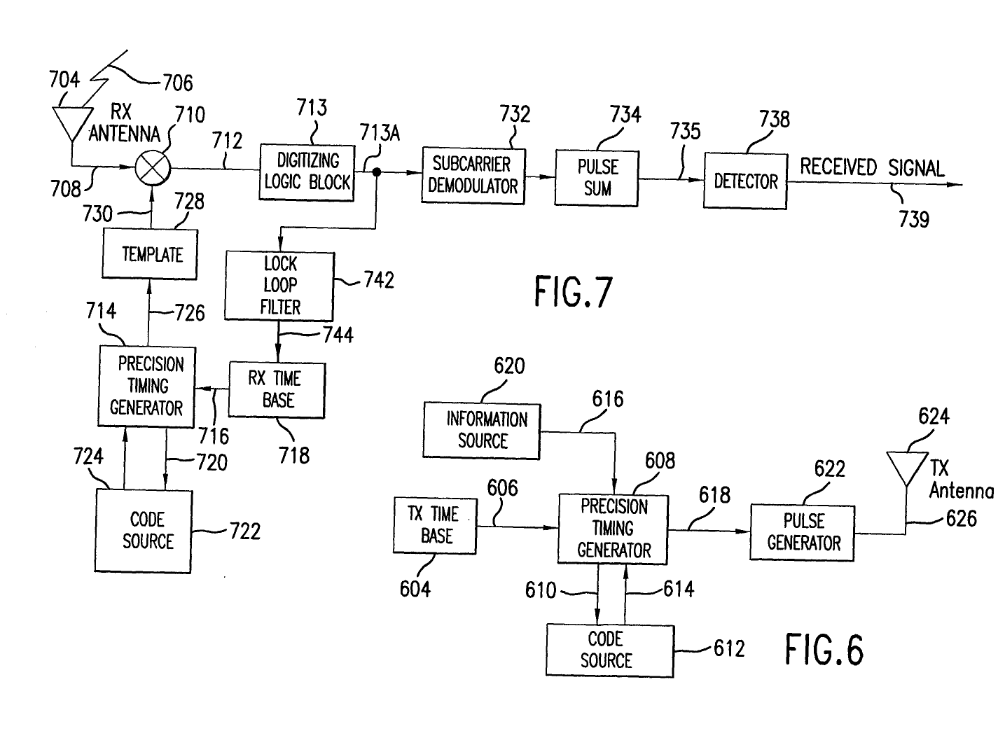

An exemplary embodiment of an impulse radio transmitter 602 of an impulse radio communication system having one subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and lowjitter, on the order of picoseconds (ps). The voltage control to adjust the VCO center frequency is set at calibration to the desired center frequency used to define the transmitter's nominal impulse repetition rate. The periodic timing signal 606 is supplied to a precision timing generator 608.

The precision timing generator 608 supplies synchronizing signals 610 to the code source 612 and utilizes the code source output 614 together with an internally generated subcarrier signal (which is optional) and an information signal 616 to generate a modulated, coded timing signal 618.

The code source 612 comprises a storage device such as a random access memory (RAM), read only memory (ROM), or the like, for storing suitable PN codes and for outputting the PN codes as a code signal 614. Alternatively, maximum length shift registers or other computational means can be used to generate the PN codes.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger to generate output pulses. The output pulses are sent to a transmit antenna 624 via a transmission line 626 coupled thereto. The output pulses are converted into propagating electromagnetic impulses by the transmit antenna 624. In the present embodiment, the electromagnetic pulses are called the emitted signal, and propagate to an impulse radio receiver 702, such as shown in FIG. 7, through a propagation medium, such as air, in a radio frequency embodiment. In a preferred embodiment, the emitted signal is wide-band or ultrawide-band, approaching a monocycle impulse as in FIG. 1A. However, the emitted signal can be spectrally modified by filtering of the pulses. This filtering will usually cause each monocycle impulse to have more zero crossings (more cycles) in the time domain. In this case, the impulse radio receiver can use a similar waveform as the template signal in the cross correlator for efficient conversion.

II.12. Exemplary Receiver

An exemplary embodiment of an impulse radio receiver 702 (hereinafter called the receiver) for the impulse radio communication system is now described with reference to FIG. 7. More specifically, the system illustrated in FIG. 7 is for reception of digital data wherein one or more pulses are transmitted for each data bit.

The receiver 702 comprises a receive antenna 704 for receiving a propagated impulse radio signal 706. A received signal 708 from the receive antenna 704 is coupled to a cross correlator or sampler 710 to produce a baseband output 712. The cross correlator or sampler 710 includes multiply and integrate functions together with any necessary filters to optimize signal to noise ratio. The baseband output 712 can be applied to a digitizing logic block 713 to produce a digitized or digital baseband output 713a. Digitizing logic block 712 can include, for example, a Sample-and-Hold (S/H) stage followed by an Analog-to-Digital (A/D) converter. Digital baseband output 713a includes digital words representing sampled amplitudes of digital baseband output 712. An advantage of digitizing baseband output 712 is that all subsequent signal processing of digital baseband output 713a can be implemented using digital techniques in a digital baseband architecture. Such a digital baseband architecture can be implemented using, for example, digital logic in a gate array, a digital signal processor, and/or a microprocessor. The digital baseband architecture is inherently immune to adverse effects arising from stressful environmental factors, such as impulse radio operating temperature variations and mechanical vibration. In addition, the digital baseband architecture has manufacturing advantages over an analog architecture, such as improved manufacturing reproducibility and reliability.

The receiver 702 also includes a precision timing generator 714, which receives a periodic timing signal 716 from a receiver time base 718. This time base 718 is adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter 602 to generate the propagated signal 706. Thus, the timing of the template pulse train 730 matches the timing of the received signal pulse train 708, allowing the received signal 708 to be synchronously sampled in the correlator 710. The correlator 710 ideally comprises a multiplier followed by a short-term integrator to sum the multiplier product over the pulse interval. Further examples and details of correlation and sampling processes can be found in the above-reference commonly owned patents and commonly owned and copending U.S. patent application No. 09/356,384, filed Jul. 16, 1999, entitled “Baseband Signal Converter Device for a Wideband Impulse Radio Receiver,” which is incorporated herein by reference.

The digitized output of the correlator 710, also called digital baseband signal 713a, is coupled to a subearrier demodulator 732, which demodulates the subcarrier information signal from the subcarrier. If digitizing logic block 713 is not used in the receiver, then baseband output 712 is provided directly from correlator 712 to the input of subcarrier demodulator 732. The purpose of the optional subcarrier process, when used, is to move the information signal away from DC (zero frequency) to improve immunity to low frequency noise and offsets. The output of the subcarrier demodulator 732 is then filtered or integrated in a pulse summation stage 734. The pulse summation stage produces an output representative of the sum of a number of pulse signals comprising a single data bit. The output of the pulse summation stage 734 is then compared with a nominal zero (or reference) signal output in a detector stage 738 to determine an output signal 739 representing an estimate of the original information signal 616.

The digital baseband signal 713a is also input to a lowpass filter 742 (also referred to as lock loop filter 742). A control loop comprising the lowpass filter 742, time base 718, precision timing generator 714, template generator 728, and correlator 710 is used to generate a filtered error signal 744. The filtered error signal 744 provides adjustments to the adjustable time base 718 to time position the periodic timing signal 726 in relation to the position of the received signal 708. In a transceiver embodiment, substantial economy can be achieved by sharing part or all of several of the functions of the transmitter 602 and receiver 702. Some of these include the time base 718, precision timing generator 714, code source 722, antenna 704, and the like.

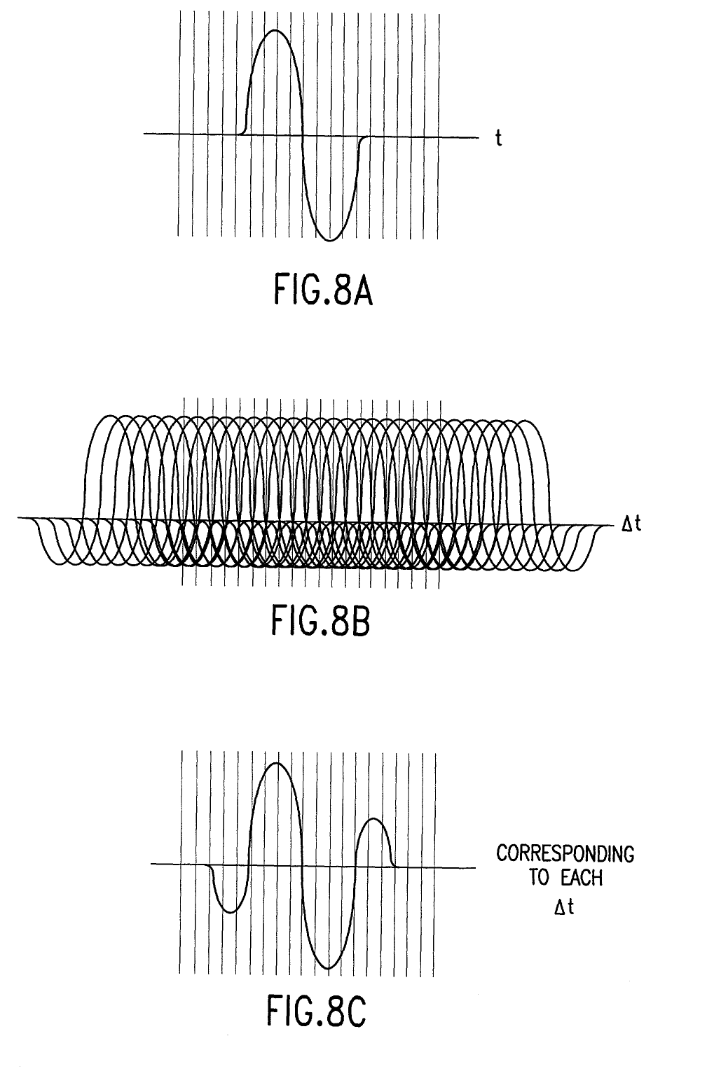

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the correlator (multiplier and short time integrator) for each of the time offsets of FIG. 8B. Thus, this graph, FIG. 8C, does not show a waveform that is a function of time, but rather a function of time-offset, i.e., for any given pulse received, there is only one corresponding point which is applicable on this graph. This is the point corresponding to the time offset of the template signal used to receive that impulse.

Further examples and details of subcarrier processes and precision timing can be found described in U.S. Pat. No. 5,677,927, titled “An Ultrawide-Band Communications System and Method”, and commonly owned co-pending application 09/146,524, filed Sep. 3, 1998, titled “Precision Timing Generator System and Method”, both of which are incorporated herein by reference.

III. Preferred Embodiments

III.1. One-of-Many Positions Modulation

As mentioned above, the present invention relates to new types of modulation schemes for use in impulse radio communications systems. In one embodiment, what shall be referred to as “one-of-many positions modulation” is used. According to the present invention, an impulse is placed within one of a plurality of widely separated positions within a time frame. If two widely separated positions are used within a time frame, then each position can represent one of two data states (e.g., a 0 bit, or a 1 bit). If, for example, four widely separated positions are used within a time frame, then four data states can be represented (e.g., each position can represent two bits, i.e., 00, 01, 10, or 11). If eight widely separated positions are used within a time frame, then each position can represent three bits (e.g., 000, 001, 010, 011, 100, 101, 110, or 111).

The term “widely separated position” minimally means that the positions within a time frame do not overlap. In contrast, many previously disclosed time position modulation schemes dither an impulse, based on information, less than ½ the width of an impulse. For example, if an impulse width was 0.5 nsec in a previously disclosed impulse radio system, such a system may only dither each impulse approximately 150 psec based on information modulation. In the present invention, each impulse is dithered by at least ½ the impulse width, i.e., at least 0.25 nsec for this example, based on information modulation. Preferably, in the present invention, the dither of each impulse based on information modulation is significantly more than the impulse width of the impulse, e.g., by 5.0 nsec for this example. By information modulating each impulse by significantly more than the impulse width, the adverse effects of multipath reflections are further avoided. That is, if each different modulation state of an impulse is widely spaced apart, there is less of a probability that delayed multipath reflections will cause an incorrect demodulation decision. This also reduces demodulation decision errors that are due to jitter (e.g., clock jitter). This results in an improved error rate (e.g., an improved bit error rate). Information modulating each impulse by significantly more than the impulse width also results in an improved signal to noise ratio over systems and methods that use the typical relatively small information dithering. Additionally, because an impulse can be placed more places within a frame, the one-of-many positions information modulation scheme results in many additional modulation states, and thus increased data throughput speeds.

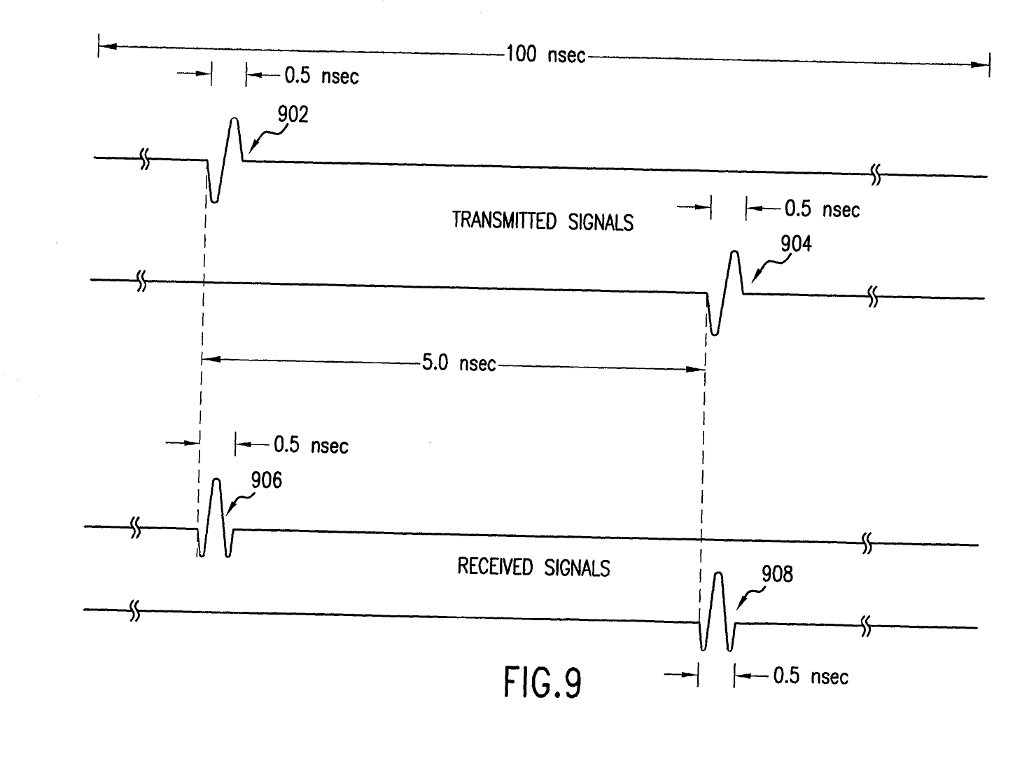

A simple example of one-of-many positions modulation can be explained with reference to FIG. 9. In this example, an impulse waveform 902 (or a plurality of impulse waveforms 902) is used to represent a binary “0” symbol, and an impulse waveform 904 (or a plurality of impulse waveforms 904) is used to represent a binary “1” symbol.

In the time domain, waveforms 902 and 904 can be described mathematically by:

$${f}_{mono} ( t ) = \sqrt{e} ( \frac{t}{σ} ) {ⅇ}^{\frac{- {t}^{2}}{2 {σ}^{2}}}$$

Where,

σ is a time scaling parameter,

t is time,

ƒₘₒₙₒ(t) is the waveform voltage, and

e is the natural logarithm base.

The frequency domain spectrum of the above waveforms is:

$${F}_{mono} ( f ) = {( 2 π )}^{\frac{3}{2}} σ f {ⅇ}^{- 2 {( πσ f )}^{2}}$$

The center frequency (ƒ_{c}), or frequency of peak spectral density is:

$${f}_{c} = \frac{1}{2 π σ}$$

Impulses 902 and 904 are exemplary waveforms associated with transmitted signals (e.g., signals transmitted through the air from a transmitter to a receiver). Once impulses 902 and 904 are received by an antenna of a receiver, their waveforms typically resemble waveform 906 and waveform 908, respectively. More specifically, waveform 906 is approximately the first derivative of waveform 902, and waveform 908 is approximately the first derivative of waveform 904. This occurs due to the receive antenna response. Because waveforms 906 and 908 resemble a “w”, they shall be referred to as “w-pulses” or “triplets”. In an exemplary embodiment of the present invention, w-pulse 906 (or a plurality of w-pulses 906) corresponds to a binary “0” and w-pulse 908 (or a plurality w-pulses 908) corresponds to a binary “1”. It is noted that a receive antenna does not necessarily differentiate a received signal. Thus, if a receive antenna does not differentiate a received signal, then the pulse waveforms of a received signal should resemble the pulse waveforms of a transmitted signal.

As described above, impulse radio systems can deliver one or more data bits per impulse. However, impulse radio systems more typically use impulse trains, not single pulses, for each data bit. Thus, a train of pulses 902 (e.g., 100 pulses 902) can be used to represent a binary “0” and a train of pulses 904 (e.g., 100 pulses 904) can be used to represent a binary “1”. Impulse trains are often used because of the additional benefits that can be obtained by using more than one impulse to represent one digital information bit. The received signal from the ensemble of pulses associated with each bit is combined in a process referred to as integration gain. The combination process is basically the summation of the received signal plus noise energy associated with each impulse over the number of pulses for each bit. The voltage signal-to-noise ratio improves roughly by the square root of the number of pulses summed. Proper summation requires that the timing be stable and accurate over the entire integration (summing) time.

III.1.A. Transmitter

A transmitter that is substantially similar to transmitter 602, described above in the discussion of FIG. 6, can be used to transmits impulses that are modulated using the above described one-of-many positions modulation scheme (e.g., to transmit impulses 902 and 904). What is important is that precision timing generator 608 produces timing signal 618 (which, may or may not be coded, depending on implementation) based on the one-of-many positions modulation scheme that has been chosen for implementation.

III.1.B. Receiver

FIG. 1O is a block diagram of an exemplary impulse radio receiver 1002 for receiving one-of-many positions modulated signals, according to an embodiment of the present invention. More specifically, receiver 1002 is for receiving one-of-two positions modulated signals. An example of a one-of-two positions modulation scheme was described above in connection with FIG. 9.

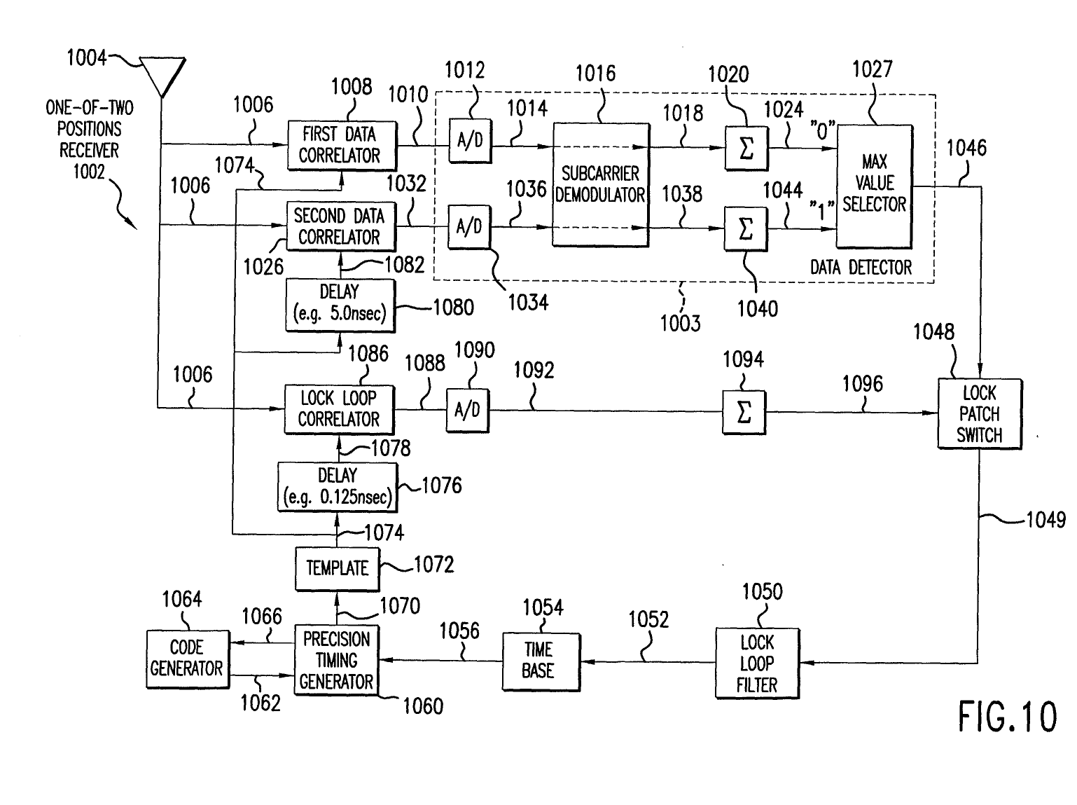

Referring to FIG. 10, receiver 1002 includes an antenna 1004 for receiving a propagated impulse radio signal. In one embodiment, antenna 1004 is designed such that it differentiates the received propagated impulse radio signal. In such an embodiment, received signal 1006 resembles the first derivative of the propagated impulse radio signal. For example, as discussed above, waveform 906 is the first derivative of impulse 902, and waveform 908 is the first derivative of impulse 904. In another embodiment, antenna 1004 does not differentiate the received propagated impulse radio signal.

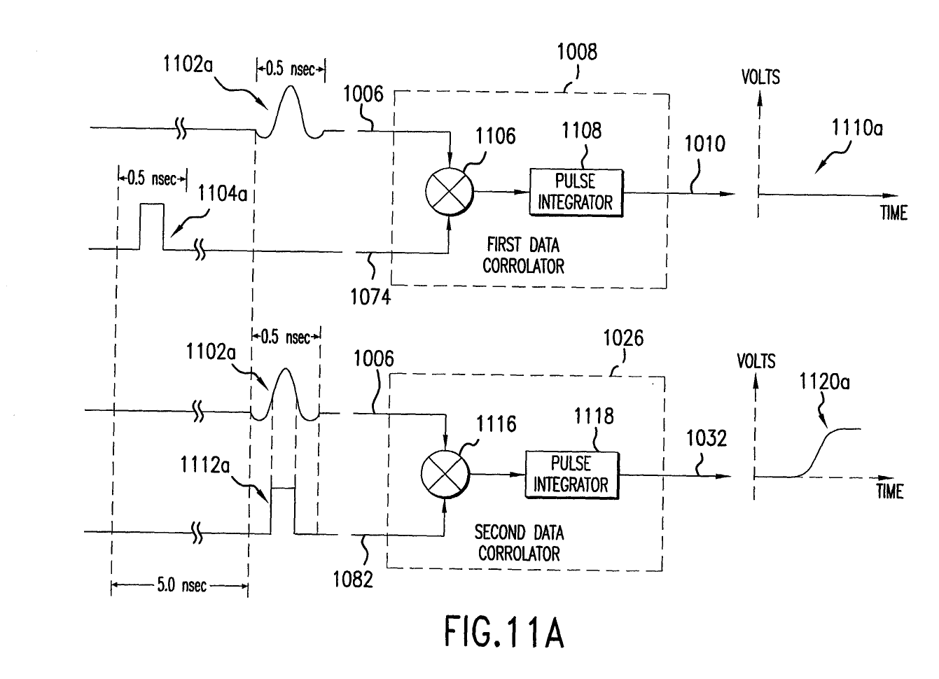

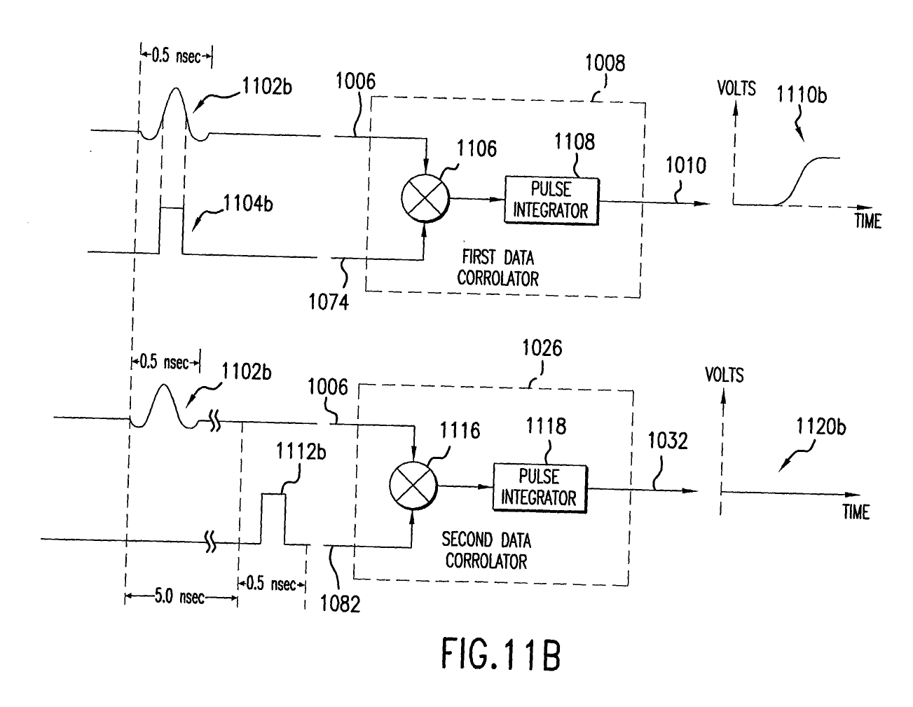

Received signal 1006 is input to a first data correlator 1008 (also called first sampler 1008). By correlating received signal 1006 with a template signal 1074 (also referred to as a reference signal 1074), discussed in more detail below, correlator 1008 produces a first baseband output signal 1010 (also referred to as first correlator output signal 1010, or first sample 1010). First data correlator 1008 ideally comprises a multiplier followed by a short term integrator to sum the multiplied product over the pulse interval (as shown in FIGS. 11A and 11B).

Received signal 1006 is also input to a second data correlator 1026 (also referred to as second sampler 1026). By correlating received signal 1006 with a delayed template signal 1082, correlator 1026 produces a second baseband output signal 1032 (also referred to as second correlator output signal 1032, or second sample 1032). Second data correlator 1026 ideally comprises a multiplier followed by a short term integrator to sum the multiplied product over the pulse interval (as shown in FIGS. 11A and 11B).

Received signal 1006 is also input to lock loop correlator 1086 that is used in a lock loop that corrects drifts in a receiver time base 1054. It is important to correct drifts in time base 1054 so that first data correlator 1008 and second data correlator 1026 sample received signal 1006 at the appropriate times. The lock loop function is described in additional detail below.

Receiver 1002 also includes a precision timing generator 1060, which receives a periodic timing signal 1056 from receiver time base 1054. Time base 1054 is adjustable and controllable in time, frequency, and/or phase, as required by the lock loop (described below) in order to lock on the received signal 1006. Precision timing generator 1060 provides a synchronization signal 1066 to an optional code generator 1064 and receives a code control signal 1062 (also referred to as coding signal 1062) from optional code generator 1064. Precision timing generator 1060 utilizes periodic timing signal 1056 and optional code control signal 1062 to produce a (coded) timing signal 1070. Template generator 1072 (also referred to as pulse generator 1072, or reference signal generator 1072) is triggered by (coded) timing signal 1070 and produces a train of template signal pulses 1074 (also referred to as reference signal pulses 1074) ideally having waveforms substantially equivalent to each impulse of received signal 1006. For example, if antenna 1004 differentiates a received propagated signal, then template signal ideally 1074 consists of pulses that are substantially equivalent to the first derivative of the propagated pulses. More likely, template signal 1074 consists of square pulses, because square pulses are much easier to generate. Where template signal 1074 consists of square pulses, template generator 1072 is not necessary if precision timing generator 1060 outputs square pulses having the appropriate shape to be used by correlators 1008 and 1026. Further, where template signal 1074 consists of square pulses, the width of each square pulse is preferably somewhat less than ½ the pulse width of a received impulse and centered about the center peak of the received impulse. For example, where received impulses are approximately 0.5 nsec wide, the square pulses of template signal are preferably approximately 0.15 nsec wide.

Template signal 1074 is used by first data correlator 1008 to sample received signal 1006, as discussed above. Template signal 1074 is also delayed by an amount of time (e.g., 5.0 nsec), and the delayed template signal 1082 is used by second data correlator 1026 to sample received signal 1006, as discussed above. The amount of time that template signal 1074 is delayed is the amount of separation that is between the two different information modulation states in the one-of-two positions modulation scheme. In the example shown in FIG. 9, the two different impulse modulations states are 5.0 nsec apart. Thus, a 5.0 nsec delay 1080 can be used to produce the appropriate delay.

It is noted that time base 1054, precision timing generator 1060, template generator 1072 and delays 1080 and 1076 can be combined into a single sampling/timing generator that provides the appropriate reference signals to first data correlator 1008, second data correlator 1026 and lock loop correlator 1086 at the precise times to appropriately sample received signal 1006. However, these elements are shown as being distinct elements to better explain the present invention. What is important is that received signal 1006 is sampled at each time position that an impulse may exist within each frame. It is also important that received signal 906 is sampled at a point in time (e.g., a zero crossing of a received impulse) that enables corrections of timing offsets. It is noted that the sampling used to correct timing offsets does not need to occur every frame, only enough times to track oscillator instability and potential motion between a transmitter and receiver. The inventors have found that a 1 KHz lock bandwidth is suitable for many applications.

If code generator 1064 is used, then the code for receiving a given signal is the same code utilized by the originating transmitter (e.g., used by code generator 612 of transmitter 602) to generate the propagated signal. Thus, the timing of template impulse train 1074 (also referred to as template signal 1074 or reference signal 1074) matches the timing of received signal impulse train 1006, allowing received signal 1006 to be synchronously sampled by correlators 1008 and 1026.

Baseband output 1010 of first data correlator 1008 is preferably provided to an analog to digital converter (A/D) 1012, which outputs a digital signal 1014 representative of output 1010 of first data correlator 1008. Similarly, baseband output 1032 of second data correlator 1026 is provided to an analog to digital converter (A/D) 1034, which outputs a digital signal 1036 representative of output 1032 of second data correlator 1026. Digital signals 1014 and 1036 are provided to optional subcarrier demodulator 1016, if subcarrier modulation was used by the transmitter that generated received signal 1006. Otherwise, digital signals 1014 and 1036 are provided directly to summing accumulators 1020 and 1040, respectively. Additional details of subcarrier demodulator 1016 are discussed below.

An output 1024 of summing accumulator 1020 and an output 1044 of summing accumulator 1040 are both provided to a max value selector 1027. Max value selector 1027 and subcarrier demodulator 1016 are discussed in more detail below. However, additional details of the correlation process are provided first.

In the above discussed embodiment of receiver 1002, A/D converters 1012 and 1034, subcarrier demodulator 1016, summing accumulators 1020 and 1040 and Max value selector 1027 can be thought of as being components of a data detector 1003 (shown by dotted lines). The exact structure of data detector 1003 can be modified and simplified while still being within the spirit and scope of the present invention. At a high level, data detector 1026 produces a data signal based on outputs 1010 and 1032 of first and second correlators 1008 and 1026.

III.1.B.i. Correlation Process

FIGS. 11A and 11B show results of an exemplary correlation process performed by first data correlator 1008 and second data correlator 1026. In this exemplary embodiment, first data correlator 1008 is shown as consisting of a multiplier 1106 followed by a pulse integrator 1108 that sums the multiplied product over at least a portion of the pulse interval. Similarly, second data correlator 1026 is shown as consisting of a multiplier 1116 followed by a pulse integrator 1118.

Referring to FIG. 11A, areceived impulse 1102a (e.g., of received signal 1006) is provided to first data correlator 1008 and second data correlator 1026, as was discussed above in connection with FIG. 10. A reference pulse 1104a (i.e., of template signal 1074) is provided to first data correlator 1008. Notice that since the received impulse 1102a and the reference pulse 1104a are offset in time (i.e., they do not overlap in time), output 1010 of first data correlator 1008 is substantially zero volts (as shown by signal 1110a).

Still referring to FIG. 11A, in addition to received impulse 1102a, a reference pulse 1112a (e.g., of delayed template signal 1082) is provided to second data correlator 1026. Notice that since the received impulse 1102a and the reference pulse 1112a are substantially aligned in time, output 1032 of second data correlator 1026 is a positive voltage (as shown by signal 1120a).

Turning to FIG. 11B, adifferent received impulse 1102b (e.g., of received signal 1006) is provided to first data correlator 1008 and second data correlator 1026. A reference pulse 1104b (e.g., of template signal 1074) is also provided to first data correlator 1008. Notice that since the received impulse 1102b and the reference pulse 1104b are substantially aligned in time, output 1010 of first data correlator 1008 is a positive voltage (as shown by signal 1110b).

Still referring to FIG. 11B, in addition to received impulse 1102b, a reference pulse 1112b (e.g., of delayed template signal 1082) is provided to second data correlator 1026. Notice that since the received impulse 1102b and the reference pulse 1112b are offset in time (i.e., they do not overlap in time), output 1032 of second data correlator 1026 is substantially zero volts (as shown by signal 1120b).

The significance of the above explanation of the correlation process will be even further appreciated by the illustrative examples discussed below.

III.1.B.ii. Max Value Selector

Max value selector 1027 determines the data states (e.g., bit or bits) that an impulse, or a plurality of pulses (e.g., 100 pulses), represent. For example, assuming that 100 pulses of received signal 1006 are used to represent each data bit, max value selector 1027 makes a decision whether each 100 pulses represent a “0” bit or “1” bit.

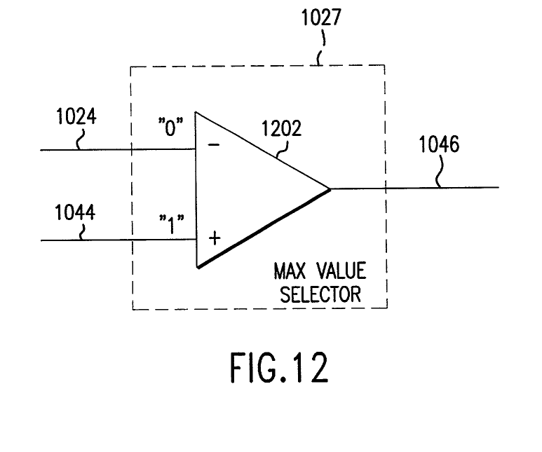

In one embodiment, show in FIG. 12, max value selector 1027 comprises a comparitor 1202. In this example embodiment, when the signal applied to the (+) input terminal (i.e., signal 1044) is greater than the signal applied to the (−) input terminal (i.e., signal 1024), output signal 1046 assumes a HIGH output state, which for example corresponds to a “1” bit. When the signal applied to the (+) input terminal (i.e., signal 1044) is less than the signal applied to the (−) input terminal (i.e., signal 1024), output signal 1046 assumes a LOW output state, which for example corresponds to a “0” bit. Thus, in this example embodiment max value selector 1027 receives a value associated with a “0” bit (e.g., signal 1024) and a value associated with a “1” bit (e.g., signal 1044) and, depending on which value is greater, makes a decision as to whether an impulse (or a plurality of impulses) represent a “0” bit or “1” bit. If A/D converters 1012 and 1034 are not used, these values referred to above are voltages. If A/D converters 1012 and 1034 are used, these values are, for example, binary numbers. In one embodiment, where A/D converters 1012 and 1034 are used, max value selector 1027 is essentially a digital comparitor that compares two values and outputs a “0” or a “1”, depending on which of the two values is greater.

III.1.B.iii. Illustrative Examples

The above discussed features of receiver 1002 and its components can be illustrated using the following example.

Referring back to FIGS. 10 and 11A, assume that received signal 1006 consists of 100 pulses 1102a (i.e., 100 frames each with an impulse 1102a). This causes signal 1010 (output from first data correlator 1008, and input to A/D converter 1012) to consists of 100 substantially zero voltage values (i.e., signal 1110a). A/D converter 1012 converts each voltage to a corresponding substantially zero value. For the sake of simplicity, assume received signal 1006 was not modulated by a subcarrier, and subcarrier demodulator 1016 is not used. Thus, assume signal 1014 is identical to 1018 (referred to collectively as signal 1014/1018) and signal 1036 is identical to signal 1038 (referred to collectively as signal 1036/1039). Accumulator 1020 adds the 100 substantially zero values (signal 1014/1018) and provides the sum (1024) to max value selector 1027.

Still referring to FIGS. 10 and 11A, second data correlator 1026 receives the same 100 impulses 1102a. This causes signal 1032 (output from second data correlator 1026, and input to A/D converter 1034) to consist of 100 positive voltage values (i.e., signal 1120a). A/D converter 1034 converts each positive voltage to a corresponding positive value. Accumulator 1040 adds the 100 values (signal 1036/1038) and provides the sum (signal 1044) to max value selector 1027. In this example, max value selector 1027 will determine that sum 1044 is greater than sum 1024, and thus that the 100 pulses 1102a represent a “1” bit. As a result, max value selector 1027 outputs a data signal 1046 that signifies a “1” bit.

Now, referring back to FIGS. 10 and 11B, assume that received signal 1006 consists of 100 pulses 1102b (i.e., 100 frames each with an impulse 1102b). This causes signal 1010 (output from first data correlator 1008, and input to A/D converter 1012) to consists of 100 positive voltage values (i.e., signal 1110b). A/D converter 1012 converts each positive voltage to a corresponding positive value. For the sake of simplicity, we will assume that received signal 1006 was not modulated by a subcarrier, and thus that subcarrier demodulator 1016 is not used. Thus, again assume that signal 1014 is identical to 1018 and signal 1036 is identical to signal 1038. Accumulator 1020 adds the 100 positive values (signal 1014/1018) and provides the sum (1024) to max value selector 1027.

Still referring to FIGS. 10 and 11B, second data correlator 1026 receives the same 100 impulses 1102b. This causes signal 1032 (output from second data correlator 1032, and input to A/D converter 1040) to consist of 100 substantially zero voltage values (i.e., signal 1120b). A/D converter 1040 converts each substantially zero voltage to a corresponding substantially zero value. Accumulator 1040 adds the 100 values (signal 1036/1038) and provides the sum (signal 1044) to max value selector 1027. In this example, max value selector 1027 will determine that sum 1024 is greater than sum 1044, and thus, that the 100 pulses 1102b represent a “0” bit. As a result, max value selector 1027 outputs a data signal 1046 that signifies a “0” bit.

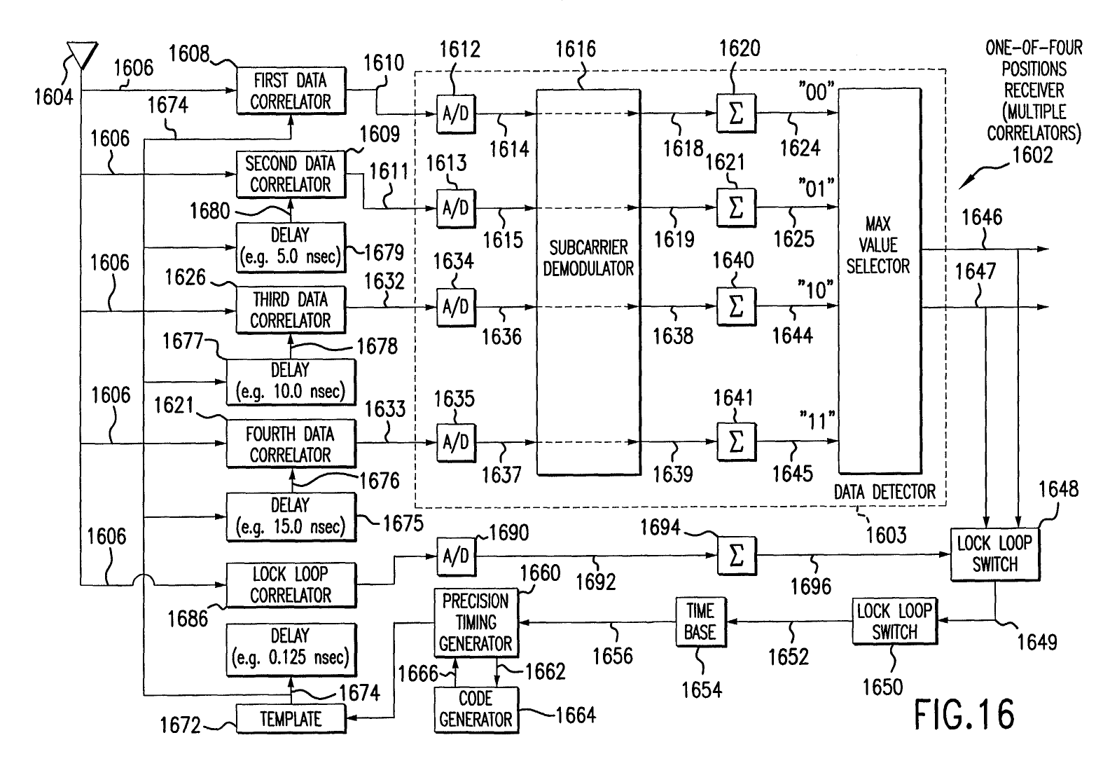

It is noted that depending on the design of the transmitter and receiver, and on the modulation scheme, a max value selector can be designed to distinguish between states other than a “0” bit and a “1” bit. For example, a max value selector 1627 of a receiver 1602 (shown in FIG. 16, and discussed below) that receives one-of-four positions modulated signals can distinguish between four data states (e.g., bits “00”, “01”, “10” and “11”).

III.1.B.iv. Lock Loop Function

Referring again to FIG. 10, it is important that first data correlator 1008 and second data correlator 1026 sample received signal 1006 at precisely the right times. Accordingly, a lock loop (also referred to as a control loop) is used to generate an error signal 1052 that corrects any drifts in time base 1054. More specifically, a control loop including lock loop filter 1050, time base 1054, precision timing generator 1060, template generator 1072, delay 1076, lock loop correlator 1086, A/D converter 1090, accumulator 1094 and lock path switch 1048, is used to generate error signal 1052. Error signal 1052 provides adjustments to the adjustable time base 1054 to time position periodic timing signal 1056 in relation to the position of received signal 1006. The function of the lock loop is described in more detail, below.

Received signal 1006 is input to a lock loop correlator 1086. Rather than correlating received signal 1006 with template signal 1072, lock loop correlator 1086 correlates received signal 1006 with a slightly delayed template signal 1078 (generated by delay 1076) and outputs a lock loop correlator output 1088. The delay caused by delay 1074 is precisely selected such that an output of lock loop correlator 1086 is theoretically zero when received signal 1006 and non-delayed template signal 1074 are synchronized. Put in other words, delay 1076 is precisely selected such that lock loop correlator 1086 samples received signal 1006 at a zero crossing when received signal 1006 and non-delayed template signal 1074 are synchronized. For example, in one embodiment, delay 1076 delays template signal 1074 by a quarter of an impulse width. Thus, if the width of each impulse is 0.5 nsec (as shown in FIG. 9), then delay 1076 delays template signal 1074 by 0.125 nsec (i.e., 0.5/4=0.125). As discussed above, this will cause the output of lock loop correlator 1086 to be zero (assuming no noise) when template signal 1074 is synchronous with received signal 1006. However, when template signal 1074 begins to lag or lead received signal 1006, output 1088 of lock loop correlator 1086 will be a positive or negative value that is used to correct time base 1054. When A/D converter 1090 is used, the correction of time base 1054 is performed in the digital domain.

In the embodiment of FIG. 10, only one lock loop is being used. Accordingly, timing errors should only be measured when first data correlator 1008 is actually sampling an impulse. Timing errors should not be measured when first data correlator 1008 is not sampling an impulse, but second data correlator is sampling an impulse. This is because the lock loop is arranged such that lock loop correlator 1086 should optimally be sampling a zero crossing of received signal 1006 when first data correlator 1008 is synchronously sampling received signal 1006. However, lock loop correlator 1086 will not be sampling a zero crossing when second data correlator is actually sampling an impulse. Rather, lock loop correlator 1086 will be sampling noise and/or delayed multipath reflections when second data correlator 1026 is sampling an impulse. This occurs because lock loop correlator 1086 is sampling received signal 1006 at a slightly delayed (e.g., 0.125 nsec) time as compared to when first data correlator 1008 is sampling received signal 1006. However, when second data correlator 1026 is actually sampling an impulse, lock loop correlator is sampling at a time that is offset 4.875 nsec (5.0−0.125=4.875) from the impulse, which is much greater than the width of the impulse (0.5 nsec). Accordingly, lock path switch 1048 is used to assure that only the appropriate outputs from lock loop correlator 1086 are provided to lock loop filter 1050. More specifically, when max value selector 1027 determines that value 1024 is greater than value 1044, the output 1046 that is provided to lock path switch 1048 enables the switch to pass an output 1096 of accumulator 1094 to lock path filter 1050. In contrast, when max value selector 1027 determines that value 1044 is greater than value 1024, the output 1046 that is provided to lock path switch 1048 disables switch 1048 and output 1096 of accumulator 1094 is not provided to lock path filter 1050. In this manner, lock path switch 1048 assures that only the appropriate outputs from lock loop correlator 1086 are used in the lock loop to generate error signal 1052.

It is noted that a second lock loop can be used, if desired, to determine errors based on the sampling by second data correlator 1026. In such an embodiment, a second lock loop correlator (not shown) would sample received signal 1006 at a point in time that is offset (e.g., delayed) by ¼ of an impulse width from the time that second data correlator 1026 samples received signal 1006. For example, the second lock loop correlator would be provided with a delayed template signal that was generated by delaying template signal 1074 by 5.125 nsec (5.0 nsec delay+0.125 nsec=5.125 nsec delay). Outputs of the second lock loop correlator could then be used in the lock loop when appropriate.

As shown in FIG. 10, error signal 1052 is provided to time base 1054. However, it is noted that time base 1054 can be implemented as part of precision timing generator 1060. In such an embodiment, error signal 1052 can be provided directly to precision timing generator 1060. Alternatively, even if time base 1054 is independent of precision timing generator 1050, error signal 1052 can be provided directly to precision timing generator 1060. What is important is that error signal 1052 is used to synchronize receiver 1002 with received impulse radio signal 1006 such that data correlators 1008 and 1026 sample received impulse radio signal 1006 at substantially optimal times for data detection.

III.1.C. Use of a Subcarrier

In the above discussed one-of-two positions modulation scheme, a first position for an impulse waveform (e.g., impulse 902) can be used to represent a first data state (e.g., a binary “0”), and a second position for an impulse waveform (e.g., e.g., impulse 904) can be used to represent a second data state (e.g., a binary “1”). As discussed above, it is often preferable to transmit multiple (e.g., 4, 8 or 100) impulses for each data state. For example, 100 impulses 902 (i.e., an impulse train) may be transmitted to represent a binary “0”, and 100 impulses 904 may be transmitted to represent a binary “1”. Also, as discussed above, each impulse of an impulse train (e.g., 100 impulses) may also be adjusted in time based on a code (e.g, code signal 1066).

It is often found desirable to include a subcarrier with the baseband signal to help reduce the effects of amplifier drift and low frequency noise. A subcarrier that can be implemented adjusts modulation according to a predetermined pattern at a rate faster than the data rate. This same pattern is then used by a receiver to reverse the process and restore the original data pattern just before detection. This method permits alternating current (AC) coupling of stages, or equivalent signal processing to eliminate direct current (DC) drift and errors from the detection process. This method, and additional details of the use of a subcarrier, is described in detail in U.S. Pat. No. 5,677,927 to Fullerton et al., which is incorporated herein by reference in its entirety. Preferably, in the present invention, the subcarrier signal used for subcarrier modulation is internally generated by precision timing generator 1008 (of transmitter 1002) and added to baseband signals (e.g., information signals which may or may not also be coded).

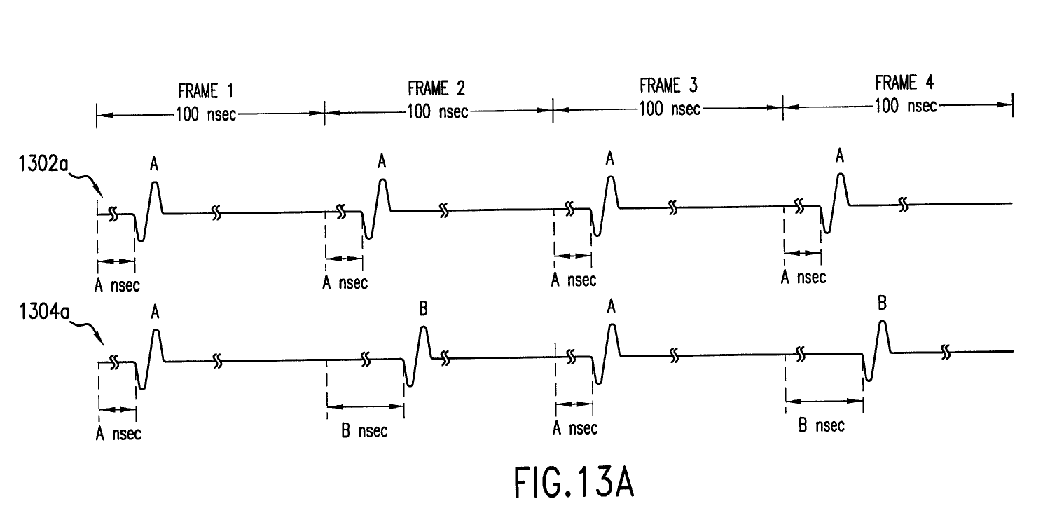

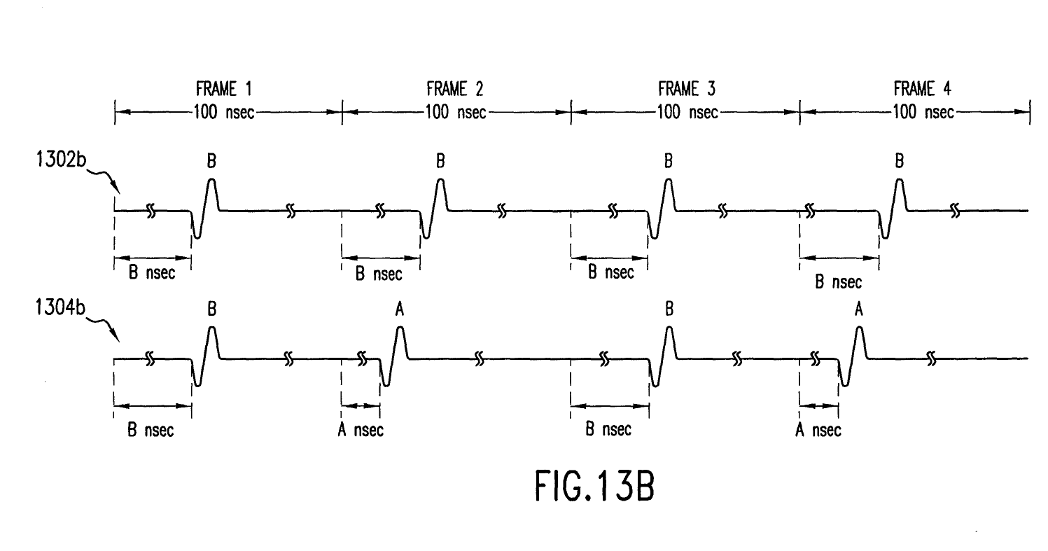

An example of subcarrier modulation can be illustrated with reference to FIGS. 13A and 13B. Assume only two transmit states: state A (i.e., impulse 902) associated with data “0”; and state B (i.e., impulse 904) associated with data “1”. Also assume that four impulses are to be transmitted for each data state. As shown in FIG. 13A, without subcarrier modulation (and assuming no coding), a signal 1302A consisting of AAAA (i.e., four impulses 902) is transmitted to represent a data “0”. As shown in FIG. 13B, without subcarrier modulation (and without coding), a signal 1302B consisting of BBBB (i.e., four impulses 1004) is transmitted to represent a data “1”. An example of a subcarrier modulation scheme is to transmit a signal 1304A consisting of ABAB to represent a data “0” (as shown in FIG. 13A) and a signal 1304B consisting of BABA to represent a data “1” (as shown in FIG. 13B). Other possibilities include, but are not limited to, transmitting a signal consisting of AABB (not shown) to represent a data “0” and a signal consisting of BBAA (not shown) to represent a data “1”. Of course, if a different number of impulses (e.g., 100 impulses) are used to represent each data state, the patterns discussed above (e.g., ABAB) can be repeated as many times as necessary (e.g., 25 times).

When subcarrier modulation is used, an impulse radio receiver must demodulate (i.e., remove) the subcarrier signal to yield an information signal. An impulse radio receiver is typically a direct conversion receiver with a cross correlator front end in which the front end coherently converts an electromagnetic impulse train of monocycle pulses to a baseband signal in a single stage. The receiver uses the same pattern, that was used to produce the subcarrier modulation, to reverse the process and restore the original data patternjust before data detection. In one embodiment of the present invention, subcarrier demodulator 1016 performs any necessary subearrier demodulation. More specifically, subcarrier demodulator 1016 provides its outputs 1018 and 1038 to the correct accumulators 1020 and 1040 so that max value selector 1027 can correctly determine which data state was represented by a train of impulses. Accordingly, the exact structure and function of subcarrier demodulator 1016 is dependent on the subcarrier modulation pattern that is used by an impulse radio transmitter (e.g., by transmitter 602).

Referring back to FIG. 10, in this embodiment, subcarrier demodulator 1016 outputs signals 1018 and 1038, which represent values that correspond to possible data states. For example, in one embodiment signal 1018 corresponds to a binary “0” and signal 1038 corresponds to a binary “1”. Signal 1018 is provided to a summing accumulator 1020, and signal 1038 is provided to a summing accumulator 1040. At the end of an integration cycle, max value selector 1027 compares an output 1024 of accumulator 1020 to an output 1044 of accumulator 1040 to determine, for example, if the data bit (associated with the received impulses) is a “0” or a “1”. Of course, accumulators 1020 and 1040 are only necessary if more than one impulse (e.g., 4, 8 or 100 impulses) are used to represent each data state (e.g., bit or bits). For example, if 100 impulses are used to represent each bit, then accumulators 1020 and 1040 will each add 100 values (i.e., accumulator 1020 will sum signals 1018 and accumulator 1040 will sum signals 1038) and provide the summation values (signals 1024 and 1044, respectively) to max value selector 1027, and then add the next 100 values and provide the summation values to max value selector 1027, and so on. If each data state (e.g., bit or bits) is represented by only one impulse, then output signals 1018 and 1038 are provided directly (i.e., without the need for accumulators 1020 and 1040) to max value selector 1027. Subcarrier demodulator 1016 provides its outputs 1018 and 1038 to the correct accumulators 1020 and 1040 so that max value selector 1027 can correctly determine which data state was represented by a train of impulses.

III.2. Alternative Embodiments

III.2.A. Single Correlator Embodiment

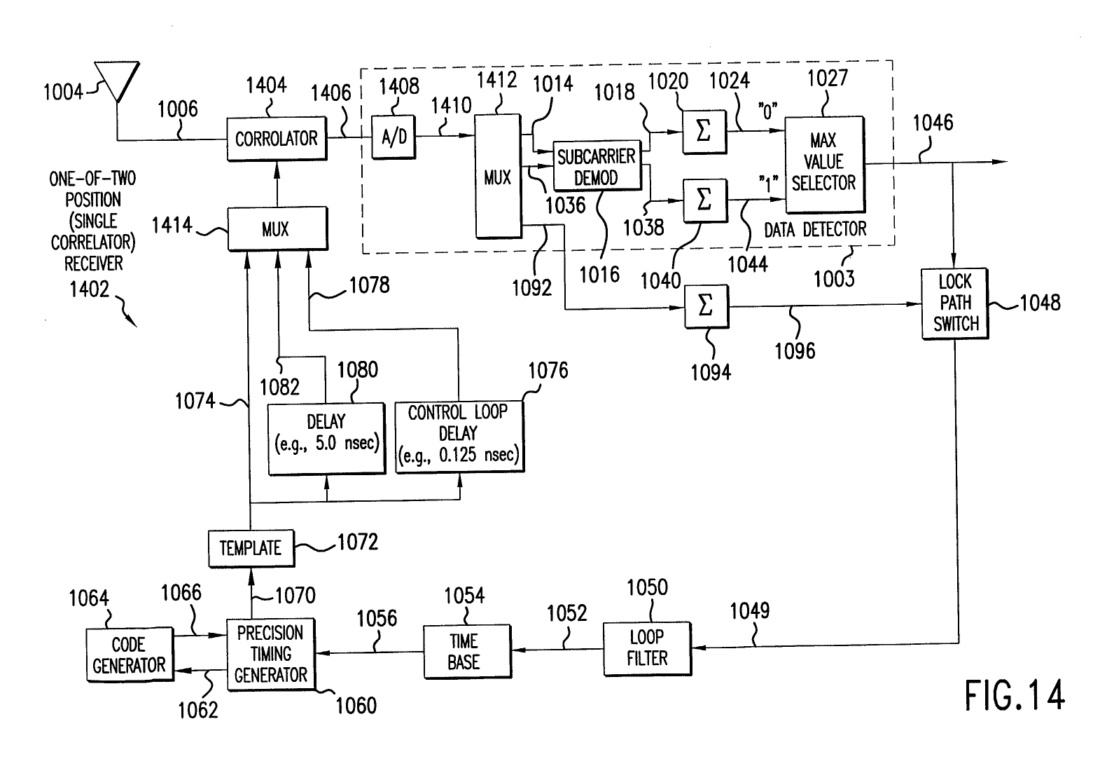

As shown in FIG. 10, receiver 1002 including two distinct data correlators 1008 and 1026 and one distinct lock loop correlator 1086. It is noted that the functions of these correlators can be combined into one or two correlators. For example, FIG. 14 shows a receiver 1402 that includes a single correlator 1404 that samples received signal 1006 three times during each frame. For at least the purpose of assisting with this description, receiver 1402 is shown as including multiplexers 1412 and 1414. Multiplexer 1414 is used to provide the appropriate reference signal 1074, 1078 or 1082 to correlator 1404. Accordingly, correlator 1404 samples received signal 1006 at a first precise time that is controlled by a phase lock loop, at a second precise time slightly delayed from the first time (e.g., by 0.125 nsec) and used in the phase lock loop, and at a third precise time delayed from the first time by the offset used in the modulation scheme (e.g., by 5.0 nsec). Outputs 1406 of correlator 1404 are provided to A/D converter 1408 which converts outputs 1406 to digital values 1410. Multiplexer 1412 separates values 1410 into three paths 1014, 1036 and 1092. The remaining elements of receiver 1402 function the same as they do in receiver 1002, discussed above.

III.2.B. One-of-Four Positions Modulation

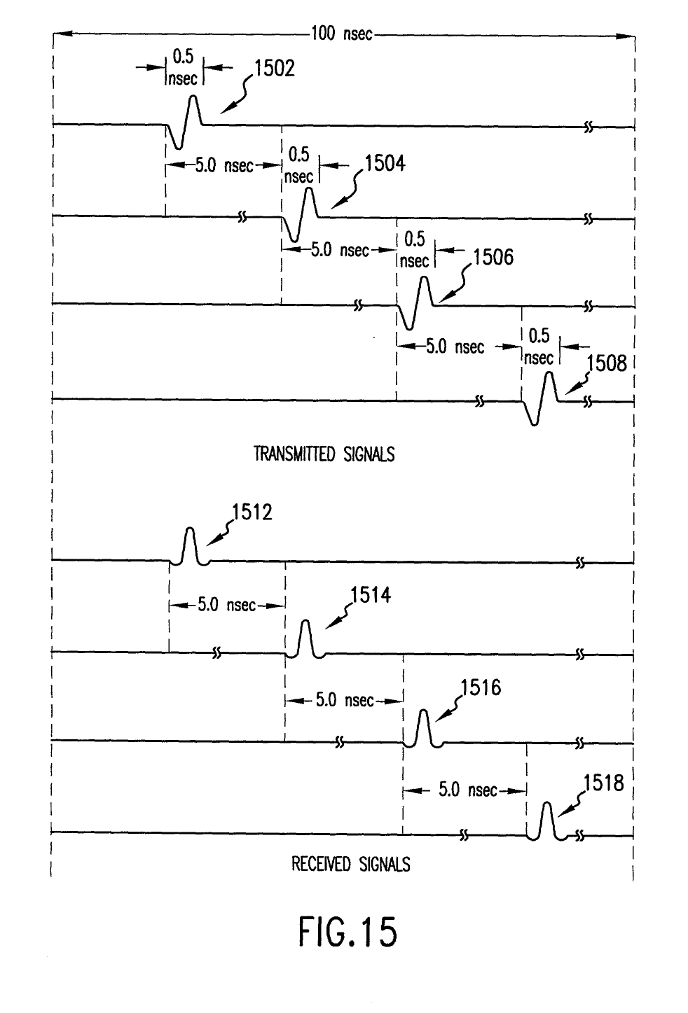

FIG. 16 shows an exemplary impulse radio receiver 1602 for receiving one-of-four positions modulated signals. An example of a one-of-four-positions modulation scheme is described in connection with FIG. 15. In this example, an impulse waveform 1502 (or a plurality of impulse waveforms 1502) is used to represent a first data state (e.g., bits “00”), an impulse waveform 1504 (or a plurality of impulse waveforms 1504) is used to represent a second data state (e.g., bits “01”), an impulse waveform 1506 (or a plurality of impulse waveforms 1506) is used to represent a third data state (e.g., bits “10”), and an impulse waveform 1508 (or a plurality of impulse waveforms 1508) is used to represent a fourth data state (e.g., bits “11”).

Impulses 1502, 1504, 1506 and 1508 are exemplary waveforms associated with transmitted signals (e.g., signals transmitted through the air from a transmitter to areceiver). Once impulses 1502, 1504, 1506 and 1508 are received by an antenna of a receiver, their waveforms typically resemble their first derivatives due to the receive antenna response, as discussed above. Thus the received impulses resemble a “w” (signals 1512, 1514, 1516 and 1518, respectively) and are referred to as “w-pulses” or “triplets”.

Referring again to FIG. 16, receiver 1602 is similar to receiver 1002, except receiver 1602 includes four data correlators 1608, 1609, 1626 and 1621, where a template signal 1680 provided to second data correlator 1609 is delayed by 5.0 nsec (i.e., from template signal 1674), a template signal 1678 provided to third data correlator 1626 is delayed by 10.0 nsec, and a template signal 1676 provide to the fourth correlator 1621 is delayed by 15.0 nsec. In this manner, first data correlator 1608 is used to sample impulses 1512, second data correlator 1604 is used to sample impulses 1514, third data correlator 1606 is used to sample impulses 1516, and fourth data correlator 1608 is used to sample impulses 1518. Receiver 1602 functions in a similar manner as receiver 1002 explained in detail above, except receiver 1602 is capable of detecting four different positions of received impulses. Thus, data detector 1603 can detect at least four different data states (e.g., bits “00”, “01”, “10” or “11). Accordingly, data detector 1603 is shown as having two parallel outputs 1646 and 1648. Data detector 1603 can alternatively have a single serial output.

In the embodiment shown, lock loop switch 1648 only provides an output 1696 (of an accumulator 1694) to a lock loop filter 1650 (as value 1649) when data outputs 1646 and 1647 (of a max value selector 1627) indicates that value 1624 is greater than output values 1625, 1644 and 1645. However, it is noted that a second, third and even forth lock loop can be used if desired, to determine errors based on the sampling by second data correlator 1609, third data correlator 1626 and fourth data correlator 1621.

The above described embodiment can be modified to support more than four different data states. For example, a one-of-five positions, a one-of-eight positions, or a one-of-N positions receiver can be implemented in a similar manner to that described above. Further, additional lock loops can be added as discussed above.

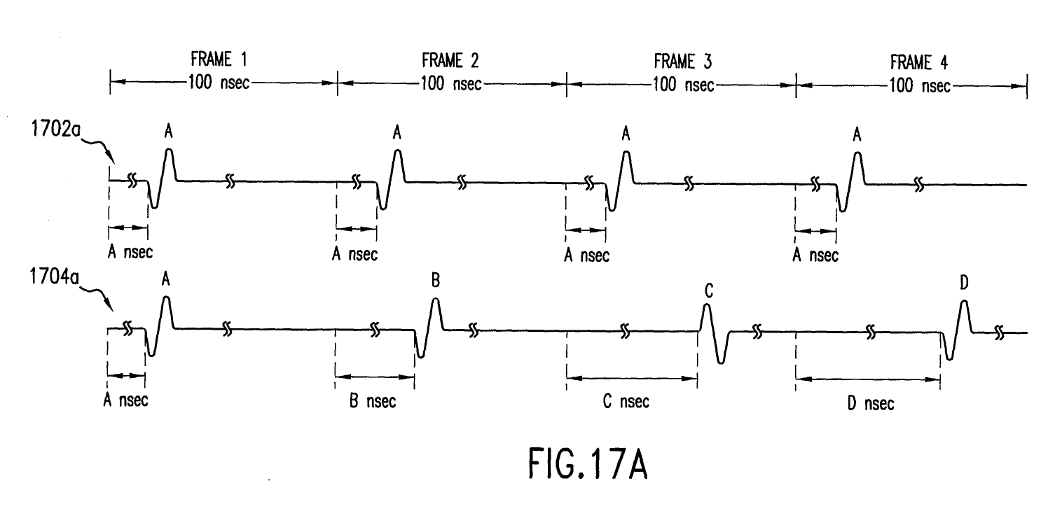

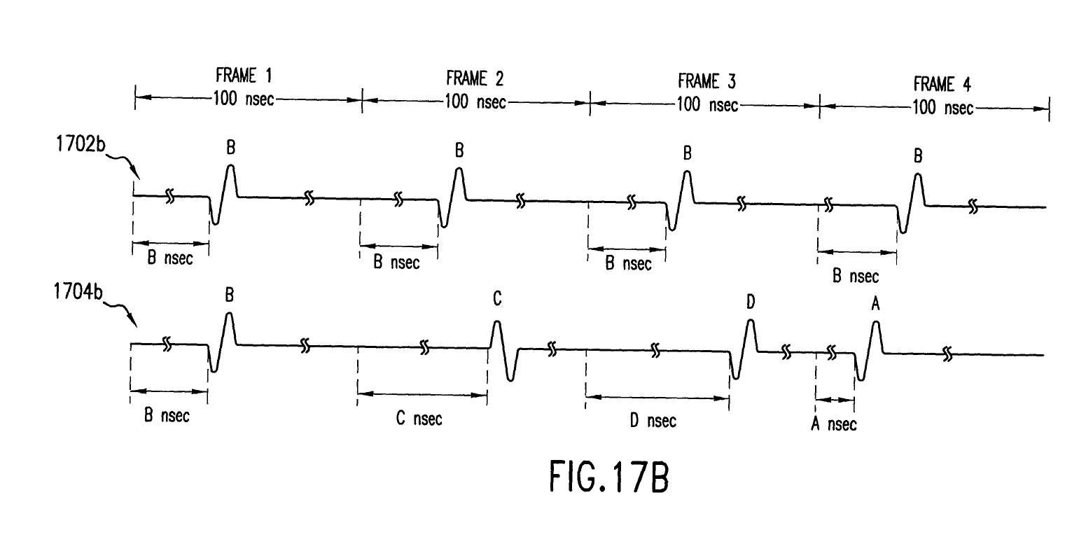

An example of subcarrier modulation, for use with a one-of-four positions modulation scheme, can be illustrated with reference to FIGS. 17A and 17B. Referring again to FIG. 15, assume four transmit states: state A (impulse 1502/1512), state B (impulse 1504/1514), state C (impulse 1506/1516), and state D (impulse 1508/1518), associated with data (e.g., bits) “00”, “01”, “10” and “11”, respectively. Also assume that four impulses are transmitted for each data state. As shown in FIG. 17A, without subcarrier modulation (and assuming no coding), a signal 1702A consisting of AAAA (i.e., four impulses 1502) is transmitted to represent data “00”. As shown in FIG. 17B, without subcarrier modulation, a signal 1702B consisting of BBBB (i.e., four impulses 1504) is transmitted to represent data “01”. Similarly, without subcarrier modulation, a signal (not shown) consisting of CCCC (i.e., four impulses 1506) is transmitted to represent data “10” and a signal (not shown) consisting of DDDD (i.e., four impulses 1508) is transmitted to represent data “11”. An example of a subcarrier modulation scheme is to transmit a signal 1704A consisting of ABCD to represent data state “00” (as shown in FIG. 17A), transmit a signal 1704B consisting of BCDA to represent data state “01” (as shown in FIG. 17B), transmit a signal consisting of CDAB to represent data state “10” (not shown), and transmit a signal consisting of DABC to represent data state “11” (not shown). Of course, if for example 100 impulses are used to represent each data state, the patterns discussed above (e.g., ABCD) can be repeated as many times as necessary (e.g., 25 times). Additionally, many other patterns can be used to represent the various data states (also referred to as symbols).

As discussed above, an impulse radio receiver is typically a direct conversion receiver with a cross correlator front end in which the front end coherently converts an electromagnetic impulse train of monocycle pulses to a baseband signal in a single stage. This same pattern is then used to reverse the process and restore the original data pattern just before detection.

In one embodiment of the present invention, subcarrier demodulator 1616 of impulse radio receiver 1602 performs any necessary subcarrier demodulation. More specifically, subcarrier demodulator 1616 provides its outputs 1618, 1619, 1638 and 1639 to the correct accumulators 1620, 1621, 1640 and 1641 so that max value selector 1627 can correctly determine which data state was represented by a train of impulses. Accordingly, the exact structure and function of subcarrier demodulator 1616 is dependent on the subcarrier modulation pattern that is used by an impulse radio transmitter (e.g., by transmitter 602).

In the above discussed embodiment of receiver 1602, A/D converters 1612, 1613, 1634 and 1035, subcarrier demodulator 1616, summing accumulators 1620, 1621, 1640 and 1644 and max value selector 1627 can be thought of as being components of a data detector 1603 (shown by dotted lines). The exact structure of data detector 1603 can be modified and/or simplified while still being within the spirit and scope of the present invention. At a high level, data detector 1603 produces parallel data output signals 1646 and 1647 based on outputs 1610, 1611, 1632 and 1633 of first, second, third, and fourth correlators 1608, 1609, 1626 and 1621. Alternatively, data detector 1603 can output a single serial data output signal.

III.2.C. Use of Threshold Comparison

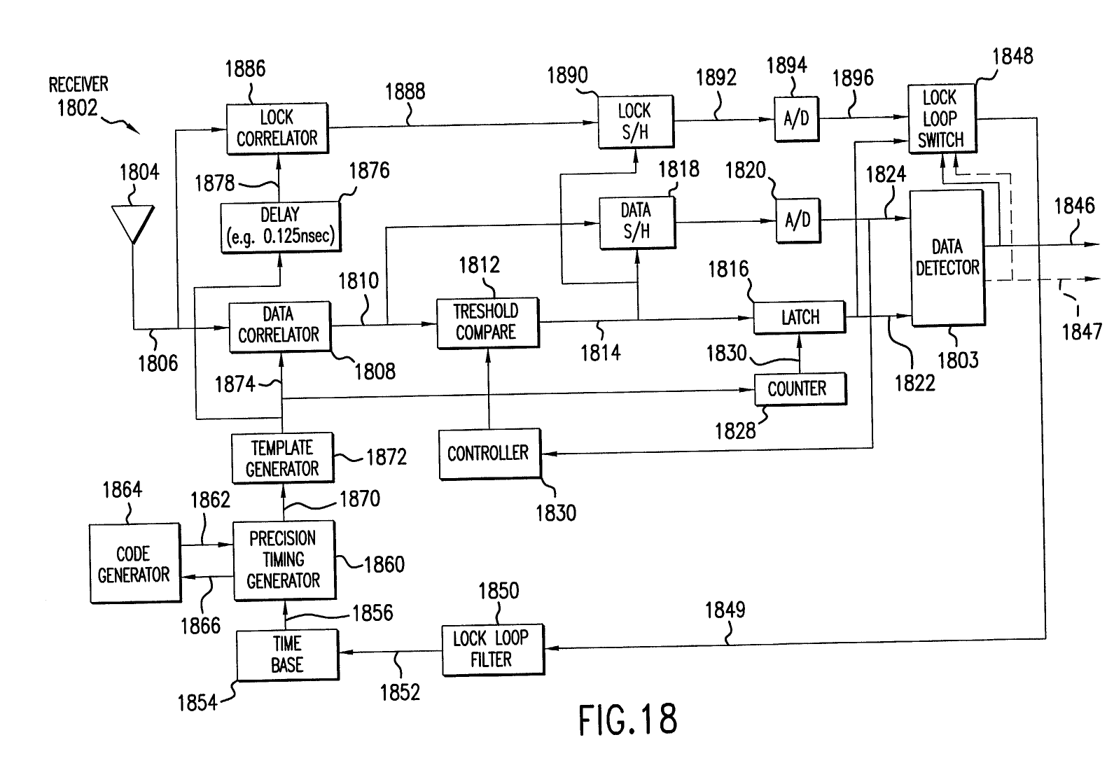

FIG. 18 shows another exemplary impulse radio receiver 1802 for receiving one-of-many positions modulated signals. Receiver 1802 includes an antenna 1804 for receiving a propagated impulse radio signal. Received signal 1806 is input to a data correlator 1808 (also called sampler 1808). By correlating received signal 1806 with a template signal 1874 (also referred to as a reference signal 1874), discussed in more detail below, data correlator 1808 produces a baseband output signal 1810 (also referred to as a correlator output signal 1810, or correlator output 1810). Correlator 1808 ideally comprises a multiplier followed by a short term integrator to sum the multiplied product over the pulse interval.

Received signal 1806 is also input to lock loop correlator 1886 that is used in a lock loop that corrects drifts in a receiver time base 1854. It is important to correct drifts in time base 1854 so that data correlator 1808 samples received signal 1806 as the appropriate times. The lock loop function is described in additional detail below.

Receiver 1802 also includes a precision timing generator 1860, which receives a periodic timing signal 1856 from receiver time base 1854. Time base 1854 is adjustable and controllable in time, frequency, and/or phase, as required by the lock loop (described below) in order to lock on the received signal 1806. Precision timing generator 1860 provides a synchronization signal 1866 to an optional code generator 1864 and receives a code control signal 1862 (also referred to as coding signal 1862) from optional code generator 1864. Precision timing generator 1860 utilizes periodic timing signal 1856 and optional code control signal 1862 to produce a (coded) timing signal 1870. Template generator 1872 (also referred to as a pulse generator 1872) is triggered by (coded) timing signal 1870 and produces a train of template signal pulses 1874 (also referred to as reference signal pulses 1874).

It is noted that time base 1854, precision timing generator 1860, template generator 1872 and delay 1876 can be combined into a single sampling/timing generator that provides the appropriate reference signals to data correlator 1808 and lock loop correlator 1886 at the precise times to synchronously sample received signal 1806. However, these elements are shown as being distinct elements to better explain the present invention.

If code generator 1864 is used, then the code for receiving a given signal is the same code utilized by the originating transmitter (e.g., used by code generator 612 of transmitter 602) to generate the propagated signal. Thus, the timing of template pulse train 1874 (also referred to as template signal 1874) matches the timing of received signal impulse train 1806, allowing received signal 1806 to be synchronously sampled by correlator 1808.

Template signal 1874 is used by data correlator 1808 to sample received signal 1806, as discussed above. The number of impulses per frame (e.g., 100 nsec) in template signal 1874 is dependent upon the modulation scheme used. For example, if one-of-two positions modulation is used, then template signal 1874 consists of two reference pulses per frame. If one-of-four positions modulation is used, then template signal 1874 consists of four reference pulses per frame. More generally, if a one-of-N positions modulation is used, then template signal 1874 consists of N reference pulses per frame.

The position of each template reference pulse within a frame is dependent upon the possible positions where impulses (of received signal 1806) may be located. For example, if one-of-four positions modulation is used, as shown in FIG. 15, then template signal 1874 consists of four template reference pulses that are spaced 5.0 nsec apart. The use of coding can place these reference pulses at various positions within each frame, depending on the coding scheme. What is important is that template signal 1874 includes the same number of reference pulses as there are modulation states, and that the position of each reference pulse is dependent on the possible positions of an impulse in received signal 1806. Put in other words, precision timing generator 1860 triggers the sampling of received signal 1806 at each possible position of an impulse within a frame of received signal 1806.

Template signal 1874 is also provided to counter 1828. Counter 1828 is incremented by one each time it receives a reference pulse of template signal 1874. Counter 1828 is designed such that it resets after the total number of possible modulations states are counted. For example, if a one-of-four positions modulation scheme is used, then counter 1828 counts up to four, and then resets. Thus, counter 1828 is reset once every frame. A count output 1830 is provided to a latch 1816, which is triggered by a threshold output 1814 of a threshold compare 1812, as discussed in more detail below.

Data correlator 1808 correlates received signal 1806 with template signal 1874 and outputs a correlator output 1810. In other words, data correlator 1808 samples received signal 1806 based on precision timing generator 1860. As discussed above, template signal 1874 includes a number of reference pulses per frame that is equal to the number of modulation states that was used by the transmitter. For example, if a one-of-four positions modulation scheme is used, then template signal 1874 includes four reference pulses per frame, causing data correlator 1808 to sample received signal 1806 four times per frame. Additionally, as discussed above, the location of each reference pulse of template signal 1874 is dependent on the possible locations where impulses (or received signal 1806) may be located. In theory, output 1810 of data correlator 1808 should be zero for all points in time except where the actual impulse is located within a frame of received signal 1806. However, this is not typically the case because received signal 1806 includes multipath reflections and noise.

Data correlator output 1810 is provided to a threshold comparator 1812 and to a data sample and hold (S/H) 1818. Threshold compare 1812, which compares data correlator output 1810 to a threshold voltage value, provides a trigger signal 1814 to both latch 1816 and data S/H 1818 when threshold compare 1812 receives a data correlator output 1810 that exceeds the threshold value. Data S/H 1818 samples the value of data correlator output 1810 so that if more than one threshold crossing is detected within a frame, the magnitudes of the threshold crossings can be compared (this is explained in more detail below). Latch 1816 stores the value of counter 1828 (in this example, counter value 1828 is one, two, three or four). If the counter is a binary counter, then the values stored in counter 1828 are, for example, “00”, “01”, “10” or “11”.

The threshold value used by threshold compare 1812 can be a predetermined value. Alternatively, the threshold value used by threshold compare 1812 can be determined by controller 1830 based on output 1824 of A/D converter 1820, and thus vary over time. In one exemplary embodiment, the threshold value determined by controller 1830 is slightly greater than one half (e.g., 60%) of the value of output 1824.

Output 1824 of data S/H 1818 is provided to A/D converter 1820, which converts the stored value of data correlator output 1810 to a digital value 1824, which is provided to data detector 1803 and to optional controller 1830. An output 1822 of latch 1816 is also provided to data detector 1803. Thus, data detector 1803 can match each digital output 1824 of A/D 1820 with in impulse position (based on output 1822 of latch 1816).

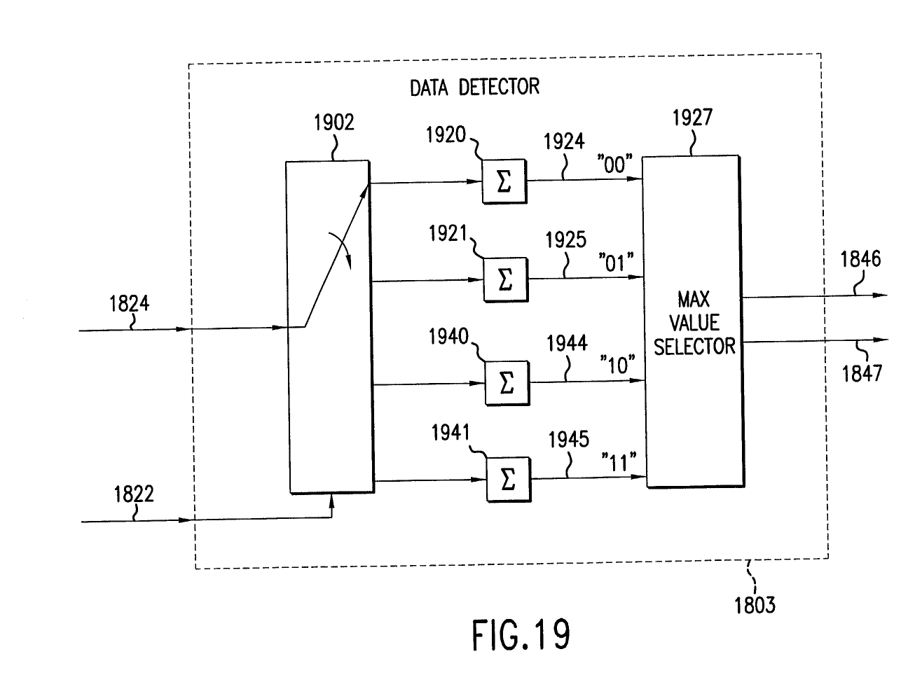

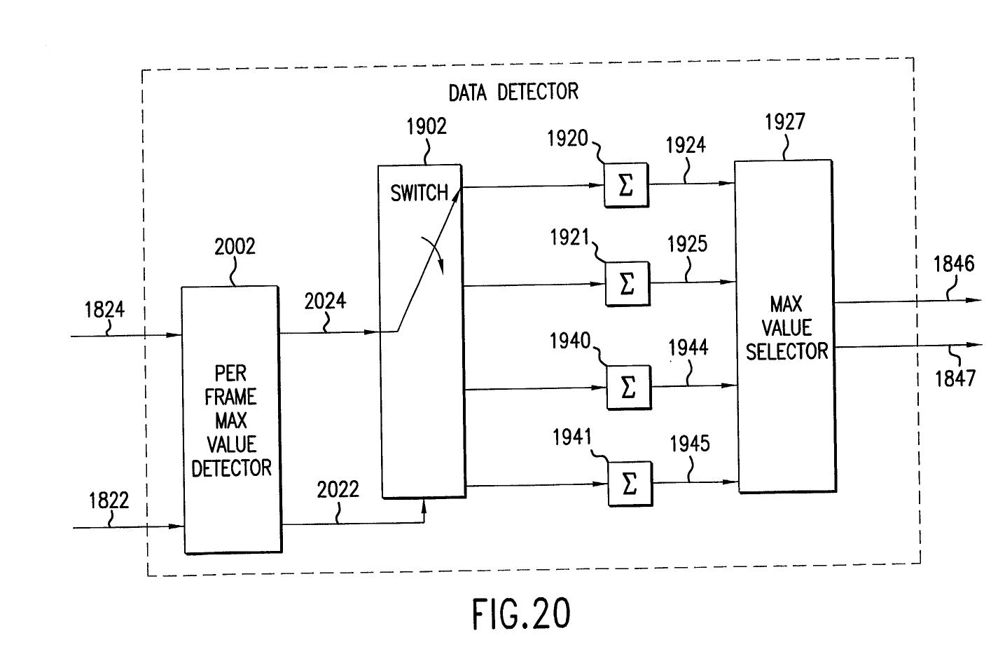

FIGS. 19 and 20 illustrate example embodiments of data detector 1803. In both embodiments, data detector 1803 receives output 1824 of A/D converter 1820 and output 1822 of latch 1816. In a first embodiment, shown in FIG. 19, output 1822 of latch 1816, which is a count value that corresponds to when the threshold is exceeded, is used to select (e.g., using a switch 1902) which summing accumulator 1920, 1921, 1940 and 1941 receives output 1824 of A/D converter 1820. For example: if the counter value stored in latch 1816 is “one”, then output value 1824 is provided to first accumulator 1920; if the counter value stored in latch 1816 is “two”, then output value 1824 is provided to second accumulator 1921; if the counter value stored in latch 1816 is “three”, then output value 1824 is provided to third accumulator 1940; and if the counter value stored in latch 1818 is “four”, then output value 1824 is provided to fourth accumulator 1941. In this embodiment, if more than one threshold crossing is detected during one frame, then more than one of accumulators 1920, 1921, 1940 and 1941 will receive a value 1824 of A/D converter 1820.

At the end of an integration cycle, a max value selector 1927 compares an output 1924 of accumulator 1920, an output 1925 of accumulator 1921, an output 1944 of accumulator 1940 and an output 1945 of accumulator 1941 to determine, for example, if the data bits (associated with a plurality of received impulses) are “00”, “01”, “10” or “11”. This determination is also referred to as a demodulation decision. Of course, accumulators 1920, 1921, 1940 and 1941 are only necessary if more than one impulse (e.g., 4, 8 or 100 impulses) are used to represent each symbol (also referred to as data state (e.g., bits)). For example, if 100 impulses are used to represent each bit, then accumulators 1920, 1921, 1940 and 1941 will each provide a summation value (signals 1924, 1925, 1944 and 1945) to max value selector once every 100 frames. If each data state (e.g., bits) is represented by only one impulse, then the outputs of switch 1902 are provided directly (i.e., without the need for accumulators 1920, 1921, 1940 and 1941) to max value selector 1927. In this example, data detector 1803 is used for demodulating one-of-four positions modulated signals. Accordingly, data detector 1803 is shown as having two parallel data outputs 1846 and 1847. The number of parallel outputs is dependent on the modulation scheme used. For example, if a one-of-eight positions modulation scheme is used, then data detector 1603 should have three parallel data outputs (i.e., because three bits are required to represent eight different states). Data detector 1803 can alternatively have a single serial output.

As discussed above, in the embodiment of FIG. 19, if more than one threshold crossing is detected during one frame, then more than one of accumulators 1920, 1921, 1940, 1941 will receive a value 1824 from A/D converter 1820. In an alternative embodiment, shown in FIG. 20, if more than one threshold crossings are detected during one frame, then a per frame max value detector 2002 determines which of the values (causing the more than one threshold crossings) is greatest in magnitude. Based on this determination, the per frame max value detector 2002 will provide the value 2024 that is greatest in magnitude to the accumulator 1920, 1921, 1940 or 1941 based on the count value 1822 (provided by latch 1816) that corresponds to that value (i.e., of greatest magnitude), using a selector signal 2022. This embodiment should have a greater signal to noise ratio than the embodiment of FIG. 19, because the probability is reduce of providing values consisting purely of noise and delayed multipath reflections to one of the accumulators 1920, 1922, 1040 or 1941.

Referring to FIG. 18, it is important that data correlator 1808 samples received signal 1006 at precisely the right times. Accordingly, a lock loop (also referred to as a control loop) is used to generate an error signal 1852 that corrects drifts in time base 1854. More specifically, a control loop including lock loop filter 1850, time base 1854, precision timing generator 1860, template generator 1872, delay 1876, lock loop correlator 1886, a lock S/H 1890, an A/D converter 1894 and a lock path switch 1848, is used to generate error signal 1852. Error signal 1852 provides adjustments to the adjustable time base 1854 to time position periodic timing signal 1856 in relation to the position of received signal 1806. The function of the lock loop is described in more detail, below.

Received signal 1806 is provided to lock loop correlator 1886. Rather than correlating received signal 1806 with template signal 1872, lock loop correlator 1886 correlates received signal 1806 with a slightly delayed template signal 1878 (e.g., generated by delay 1876) and outputs a lock loop correlator output 1888. The delay caused by delay 1876 is precisely selected such that an output of lock loop correlator 1086 is theoretically zero (assuming no noise or multipath reflections) when received signal 1806 and non-delayed template signal 1874 are synchronized. Put in other words, delay 1876 is precisely selected such that lock loop correlator 1886 samples an impulse of received signal 1806 at a zero crossing when received signal 1806 and non-delayed template signal 1874 are synchronized. For example, in one embodiment, delay 1876 delays template signal 1874 by a quarter of an impulse width. Thus, if the width of each received impulse is 0.5 nsec, then delay 1876 delays template signal 1874 by 0.125 nsec (i.e., 0.5/4=0.125). As discussed above, this should cause output 1888 of lock loop correlator 1886 to be zero when template signal 1874 is synchronous with received signal 1806. However, when template signal 1874 begins to lag or lead received signal 1806, output 1888 of lock loop correlator 1886 will be a positive or negative value that is used to correct time base 1854.

Data correlator 1808, which receives template signal 1874, samples received signal 1806 at each position where an impulse may be located within a frame. Similarly, lock loop correlator 1886, which receives delayed template signal 1874, samples received signal at precise positions where each impulse may be crossing zero. For example, if receiver 1802 receives signals that are modulated according to the one-of-four positions modulation scheme discussed above, then data correlator 1808 samples received signal 1806 four times per frame (preferably near the center of each possible impulse position), and lock loop correlator 1886 also samples received signal 1806 four time per frame. However, just as it is preferably to only use those outputs 1810 (of data correlator 1808) that exceed a threshold during data detection, it is also preferably to only use selective outputs 1888 of lock loop correlator 1886 in the lock loop to adjust time base 1854. Otherwise, noise samples will corrupt the lock loop. The selective use of specific lock loop correlator outputs 1888 is accomplished by providing trigger signal 1814 to lock loop S/H 1890, as described below.

Lock loop S/H 1890 samples the value of lock loop correlator output 1888 when it is triggered by signal 1814. An output 1892 of lock loop S/H 1890 is converted to a digital value 1896 by A/D converter 1896. Digital value 1896 is provided to lock loop switch 1848, which also receives output 1822 of latch 1816. Thus, lock loop switch 1848 can match each digital value 1896 with an impulse position (i.e., based on output 1822 of latch 1816). Lock loop switch 1848 also receives data output 1846 (and possibly additional data outputs, such as 1847, depending on the number of data states and depending on whether parallel outputs are used or a serial output is used). In this manner, if more than one threshold crossings are detected during one frame, then lock loop switch 1848 can determine which of the values (causing the more than one threshold crossings) is greatest in magnitude, and then use the corresponding digital value 1896 in the lock loop. In other words, if lock loop switch 1848 receives more than one digital value 1896 during a single frame, lock loop switch 1848 determines which digital value 1896 to provide to lock loop filter 1850 via a path 1849.

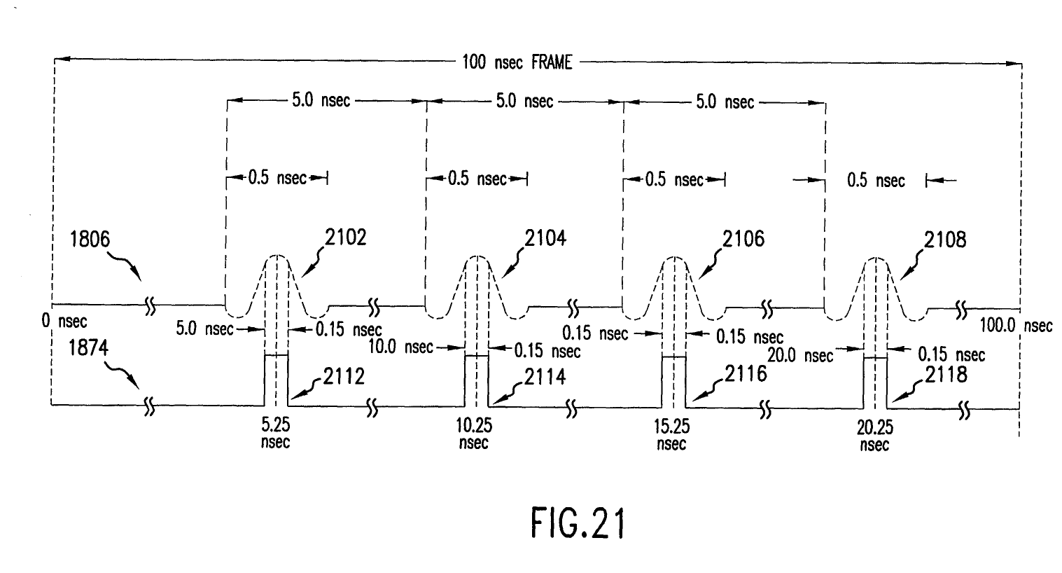

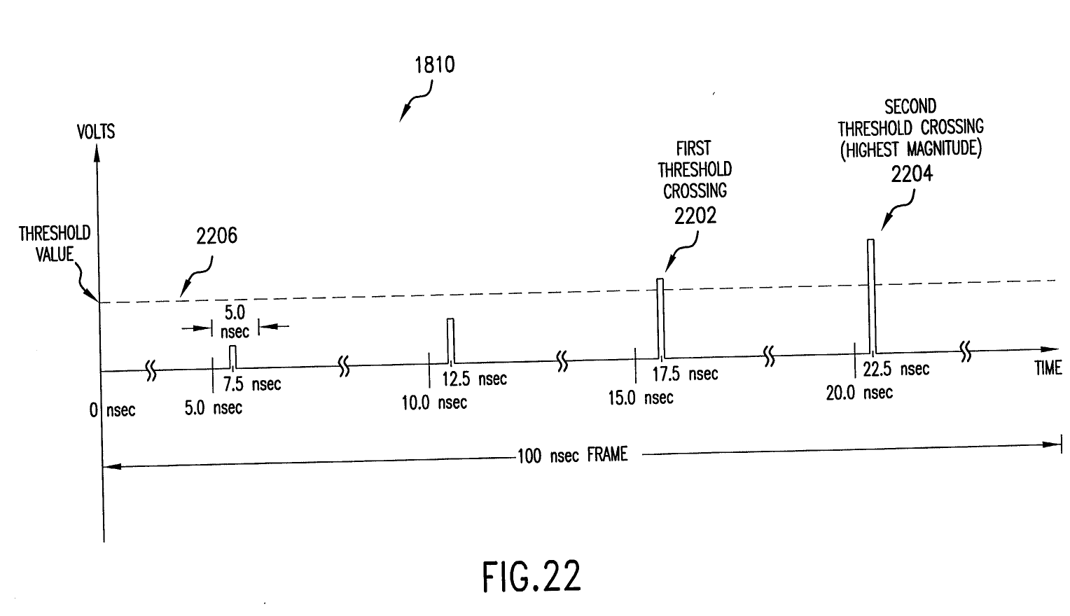

FIGS. 21 and 22 can be used to further explain the above discussed embodiment of receiver 1802. Referring to FIG. 21, assuming a one-of-four positions modulation scheme is used, four possible positions that an impulse may be located in received signal 1806 are designated by the dashed impulse waveforms 2102, 2104, 2106 and 2108. In this example, the first possible position of an impulse begins 5.0 nsec into a 100 nsec frame (where the impulse width if 0.5 nsec); the second possible position of an impulse begin 10.0 nsec into the 100 nsec frame; the third possible position of an impulse begins 15.0 nsec into the 100 nsec frame; and the fourth possible position of an impulse begins 20.0 nsec into the 100 nsec frame. Of course, the possible positions can be other locations within the frame, depending on the specific modulation scheme used by the transmitter that generated the signal corresponding to received signal 1806.

FIG. 21 also shows an example template signal 1874 that is used by data correlator 1808 to sample received signal 1806. As shown, template pulses 2112, 2114, 2116 and 2118 (also referred to as reference pulses) are preferably centered about the center of each possible impulse position. Exemplary reference pulses 2112, 2114, 2116 and 2118 are shown as being less than a half the width of the possible received impulses. More specifically, pulses 2112, 2114, 2116 and 2118 are shown as being 0.15 nsec wide, where the received impulses are approximately 0.5 nsec wide.

FIG. 22 shows an example of correlator output 1810 over a frame interval (e.g., 100 nsec). Notice, in this example, correlator output 1810 exceeds a threshold value (designated by dotted line 2206) at a first point in time 2202 and a second point in time 2204. As discussed above, in theory, output 1810 of data correlator 1808 should be zero for all points in time except for where the actual impulse is located within a frame of received signal 1806. However, this is not the case, as shown in FIG. 22, because received signal 1806 includes noise and/or delayed multipath reflections.

Referring still to FIG. 22 and also back to FIG. 19, if the data detector 1803 of FIG. 19 is used in receiver 1802 (and assuming no subcarrier modulation), then the value associated with the first threshold crossing at 2202 (at the third possible impulse position) is provided to third accumulator 1940 and the value associated with second threshold crossing 2204 (at the fourth possible impulse position) is provided to fourth accumulator 1941. Accordingly, as discussed above, both values will be used by max value selector 1927 when a demodulation decision is made. In contrast, if the data detector 1803 of FIG. 20 is used in receiver 1802, then only the value having the greatest magnitude (i.e., the value associated with the second threshold crossing, at the fourth possible impulse position) will be provided to its corresponding accumulator (i.e., 1941) and used in the demodulation decision.

III.3. Use of Artifacts During Demodulation

In a one-of-many positions modulation scheme, modulation is accomplished by placing impulses at distinct positions within a frame. In one example of a one-of-four positions modulation scheme, four distinct positions separated by 5 nsec, exists within each frame (e.g., a 100 nsec frame). In this example, modulation can be accomplished by placing an impulse at one of the four positions. For example, as discussed above, an impulse in the first position can represent bits “00”, an impulse in the second position can represent bits “01”, an impulse in the third position can represent bits “10”, and an impulse in the fourth bin can represent bits “11”. Such an example modulation scheme is discussed above with connection to FIG. 15. Referring to the received signals 1512, 1514, 1516 and 1518 of FIG. 15, these signals are shown as being essentially perfect. However, because of delayed multipath reflections and noise, it is unlikely that the received signals will resemble those shown in FIG. 15.

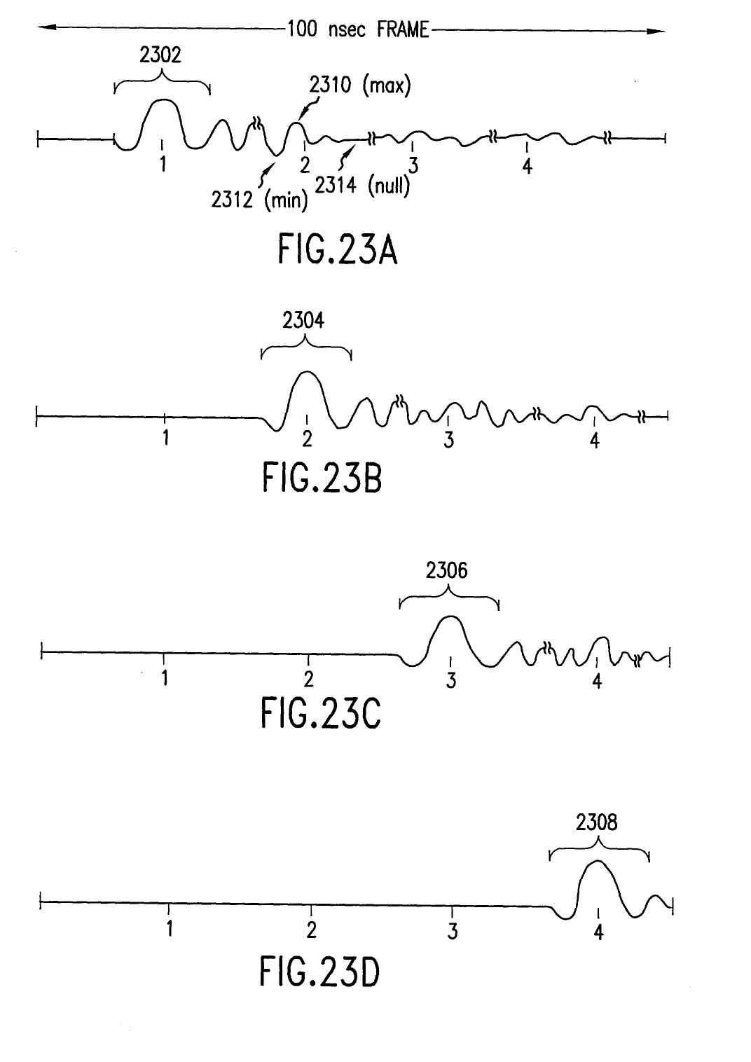

As discussed in the Impulse Radio Basics, Miltipath and Propagation section above, impulse radios are typically resistant to the effects of multipath effects because delayed multipath reflections typically arrive outside the correlation time and thus have generally been ignored. However, this is not necessarily the case when receiving impulses that have been modulated using a one-of-many positions modulation scheme. Rather, in a one-of-many positions modulation scheme, it is very probable that a delayed multipath reflection associated with an impulse placed in a first location will arrive during the correlation times (also referred to as sampling times) of downstream correlations (also referred to as downstream samples). This is illustrated in FIGS. 23A-23D, which are discussed in more detail below. Delayed multipath reflections are one example of what is referred to collectively as ringing or downstream artifacts. For the purpose of this application, ringing (also referred to as downstream artifacts) is defined as those signal attributes associated with an impulse that are located later in time than (i.e., downstream from) the intended (or expected) waveform of a received impulse. For example, referring to FIG. 23A, those signal attributes located later in time than 2302 are downstream artifacts.

In addition to delayed multipath reflections, ringing can be caused by a number of other things. For example, ringing can also be caused by components within an impulse radio transmitter and/or by components within an impulse radio receiver.

This ringing can cause demodulation decision errors if the ringing plus noise is greater than the signal (i.e., impulse) plus noise. For example, a receiver used in a one-of-four positions modulation scheme samples a received signal at least four times per frame in an attempt to determine which data state was received. If the sample value (i.e., correlation output) associated with a downsteam artifact plus noise (e.g., taken at the second position of the four positions) is greater than the sample value of the actual impulse plus noise (e.g., taken at the first position), then the receiver can make a wrong demodulation decision regarding which data state (also referred to as, symbol) is associated with the frame of the receive signal. A feature of the present invention is the use these downstream artifacts to increase the confidence of demodulation decisions. Another feature of the present invention is to adjust the downstream positions (e.,g., the second, third and fourth positions) used during transmission of impulses and to adjust the downstream sampling positions during reception of impulses, so that the disruptive effects of downstream artifacts are reduced. A further feature of the present invention is to combine the above features such that downstream positions are adjusted to maximize the confidence of a demodulation decision that includes consideration of downstream artifact measurements.

These aspects of the invention can be illustrated using FIGS. 23A-23D. As shown in FIG. 23A, when an impulse 2302 is in the first position it can cause ringing in the following three positions. As shown in FIG. 23B, when an impulse 2304 is in the second position, it can cause ringing in the third and fourth positions. As shown in FIG. 23C, when an impulse 2306 is in the third position, it causes ringing in the fourth position. When an impulse 2308 is in the fourth position, it causes no ringing in any of the other three positions. Various embodiments of the invention are described below.

III.3.A. Use of Artifacts to Increase Confidence of a Decision

In an embodiment of the present invention, a receiver is trained so that the artifacts received at downstream positions can be used to assist in making demodulation decisions. More specifically, assuming a one-of-four positions modulation scheme, a training sequence is sent from a transmitter to the receiver. In one example, the training sequence consists of a plurality of frames (e.g., 100 frames) with an impulse in the first position of each frame, followed by a plurality of frames with an impulse in the second position of each frame and then followed by a plurality of frames with an impulse in the third position of each frame. This training sequence can occur periodically (e.g., between each packet, or more likely between each of a plurality of packets) so that the receiver's knowledge of downstream artifacts can still be useful even if the receiver and/or transmitter are moving with respect to one another, if the noise pattern is varying and/or if the surfaces causing multipath reflections are moving.

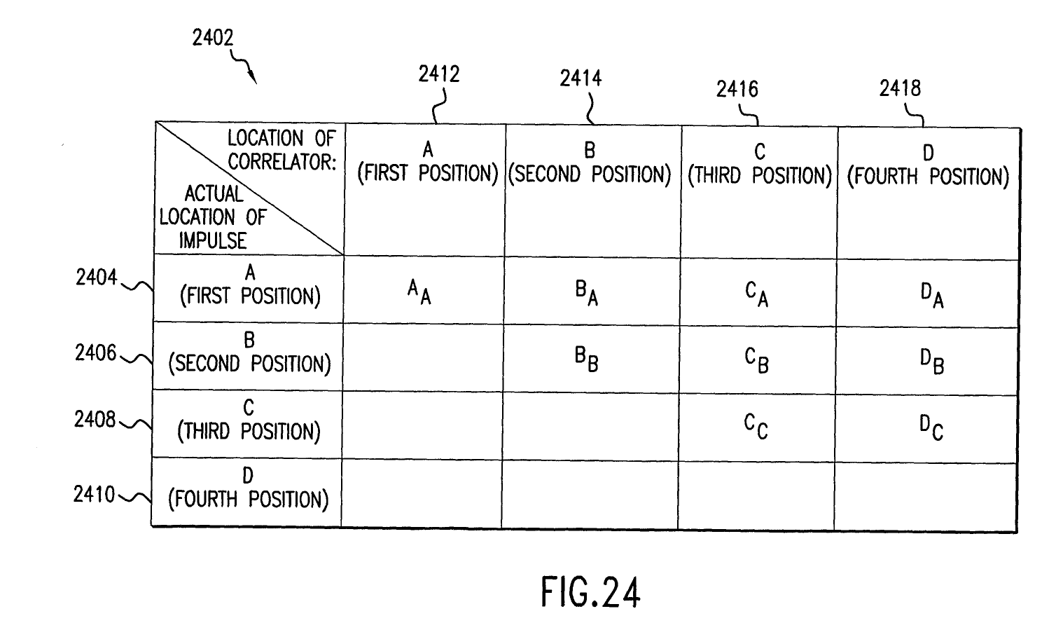

For example, referring to receiver 1602 of FIG. 16, during the training sequence, the receiver receives the plurality of impulses that are located in the first position and a first correlator locks (e.g., first data correlator 1608) onto the impulses in the first position. While the first correlator is locked, a second correlator (e.g., second data correlator 1609) samples the ringing at the second position, a third correlator (e.g., third data correlator 1626) samples the ringing at the third position, and a fourth correlator (e.g., fourth data correlator 1621) samples the ringing at the fourth position. This information is stored in an artifact table or a similar type of data structure. Next, during the training sequence, the plurality of impulses in the second position are received and the second correlator locks onto the impulses in the second position, the third correlator samples the ringing at the third position, and the fourth correlator samples the ringing at the fourth position. This information is also stored in the artifact table. Additionally, during the training sequence, the plurality of impulses in the third position are received, the third correlator locks onto the impulses in the third position, and the fourth correlator samples the ringing the fourth position. This information is also stored in the artifact table. Additionally, although not actually artifact values, values corresponding to the samples by the first correlator when the impulse is in the first position, values corresponding to the samples by the second correlator when the impulse is in the second position, and values corresponding to the samples by the third correlator when the impulse is in the third position can also be stored in the artifact table and used during demodulation decisions. This is discussed below in connection with FIG. 24.

After the training sequence if finished, the artifact table can be used to make demodulation decisions as to what symbols (also referred to as data states) are being received. For example, the receiver can predict what the second, third, and fourth correlators will see at the second, third, and fourth positions, respectively, when an impulse is in the first position. The receiver can also predict what the first correlator will see when the impulse is in the first position. Additionally, the receiver can predict what the third and fourth correlators will see in the third and fourth positions, respectively, when an impulse is in the second position. The receiver can also predict when the second correlator will see when the impulse is in the second position. Further, the receiver can predict what the fourth correlator will see when the impulse is in the third position. The receiver can also predict what the third correlator will see when the impulse is in the third position. Thus, by measuring the downstream artifacts, the confidence in decisions can be increased.

An example of an artifact table 2402 for use in a receiver that receives one-of-four positions modulated signals is shown in FIG. 24. In table 2402, “A” corresponds to the first position, “B” corresponds to the second position, “C” corresponds to the third position and “D” corresponds to the fourth position.

Referring to row 2404, after receiving a plurality of frames where the impulse is located in the first position, a value A_{A} associated with the first correlator is stored in column 2412, a downstream artifact value B_{A} associated with the second correlator is stored in column 2414, a downstream artifact value C_{A} associated with the third correlator is stored in column 2416 and a downstream artifact value D_{A} associated with the fourth correlator is stored in column 2418. Notice that the full scale letters (i.e., A, B, C and D) represents the location of the correlator (i.e., which position is being sampled by the correlator) and the subscript letters (i.e., _{A}, _{B} and _{C}) represents the actual location of the impulse within a frame. For example, referring back to FIG. 16, the value A_{A} associated with the first correlator can be the output 1624 of first accumulator 1620, the value B_{A} associated with the second correlator can be the output 1625 of second accumulator 1621, the value C_{A} associated with the third correlator can be output 1644 of third accumulator 1640 and the value D_{A} associated with the fourth correlator can be output 1645 of fourth accumulator 1641. Since the values stored in row 2404 are associated with frames where the impulse is located in the first position, values B_{A}, C_{A} and D_{A} are referred to as downstream artifact values.

Referring back to FIG. 24, and specifically referring to row 2406, after the plurality of frames where the impulse is located in the second position are received by the receiver, a value B_{B} associated with the second correlator is stored in column 2414, a downstream artifact value C_{B} associated with the third correlator is stored in column 2416 and a downstream artifact value D_{B} associated with the fourth correlator is stored in column 2418. Since the values stored in row 2406 are associated with frames where the impulse is located in the second position, values C_{B} and D_{B} are referred to as downstream artifact values.

Referring now to row 2408, after the plurality of frames where the impulse is located in the third position are received by the receiver, a value C_{C} associated with the third correlator is stored in column 2416 and a downstream artifact value D_{C} associated with the fourth correlator is stored in column 2418. Since the values stored in row 2408 are associated with frames where the impulse is located in the third position, value D_{B} is referred to as a downstream artifact value.

In addition to using downstream artifact values (e.g., B_{A}, C_{A}, D_{A}, C_{B}, D_{B} and D_{C}) to increase the confidence of decisions, the values associated with the outputs of the correlator actually sampling an impulse (e.g., values A_{A}, B_{B} and C_{C}) can also be used during demodulation decisions. This is especially useful where a downstream artifact value exceeds the value associated with the output of the correlator actually sampling an impulse (e.g., if B_{A}>A_{A})

III.3.B. Use of Artifacts to Adjust Downstream Positions of Impulses

As discussed above, in an embodiment of the present invention, downstream positions (e.,g., the second, third and fourth positions) using during transmission of impulses are adjusted and downstream sampling positions used during reception of impulses are correspondingly adjusted, so that the disruptive effects of downstream artifacts are reduced. In this embodiment, scanning correlators are used to fill an artifact table, which has more entries than the artifact table 2402 discussed in connection with FIG. 24. Additional details of scanning correlators are disclosed in commonly owned U.S. patent application No. 09/537,264, filed Mar. 29, 2000, entitled “System and Method Utilizing Multiple Correlator Receivers in an Impulse Radio System,” which is incorporated herein by reference in its entirety. During the training sequence, a plurality of frames having the impulse in the first position are sent to the receiver. The receiver receives an impulse radio signal and a first correlator of the receiver locks onto the impulses in the first position. While this first correlator remains locked onto the impulses in the first position, a one or more scanning correlators are used to sample multiple points (e.g., with each of the points separated by approximately ¼ of the width of each impulse) surrounding the remaining positions (i.e., the second, third and fourth positions) in order to populate an artifact table. From this artifact table, the receiver can determine points near the second, third, and fourth positions where the ringing causes a max positive peak (e.g., point 2310), a null (e.g., point 2314) and a max negative peak (e.g., point 2312). Some or all of the information in the artifact table can then be provided (i.e., transmitted) to the transmitter so that the transmitter can adjust the locations of the second, third, and fourth positions, to thereby increase the probability of making correct decisions. In one embodiment, the transmitter adjusts the second, third and fourth positions such that they are located at nulls of the downstream artifacts. When the transmitter changes the locations of these positions, the transmitter must inform the receiver of the changed locations so that the correlators of the receiver sample received signals at the appropriate points in time. In another embodiment, the receiver determines how the transmitter should adjust the positions of impulses (based on the artifact table) and transmits information relating to the new positions back to the transmitter.

As mentioned above, in one embodiment, the transmitter transmits impulses at the nulls near the second third and fourth positions. This can increase the confidence that a data detection decision is correct because ringing should not as significantly corrupt the downstream samples of the received signal made by the second, third, and fourth correlators. However, if the downstream artifact values are also used to make a decision (as described above, under the heading “Use of Artifacts to Increase Confidence of a Decision”), then it may not be optimal to transmit impulses at such nulls.

III.4.C. Adjust Positions of Impulses to Reduce Effects of Artifacts

The above discussed embodiments are very useful in environments where ringing (i.e., downstream artifacts) remains somewhat constant over periods of time. That is, in the above discussed embodiments, knowledge learned from earlier received signals (e.g., learned by sampling at downstream positions) is used to attempt to improve demodulation decisions (e.g., decisions as to what data states have been received) made for later received signals. However, if the knowledge learned from earlier received signals is no longer relevant to the later received signals, use of such knowledge can actual corrupt demodulation decisions rather than improve them. In other words, if downstream artifact values significantly vary over time, then they are not useful for improving demodulation decisions. This can occur, for example, in environments having constant motion (e.g., movement of a fan blade or the like). Accordingly, there is a need for improving demodulation decisions (also referred to as symbol decisions and data decisions) in such dynamic environments.

This embodiment of the present invention shifts (i.e., adjusts) the locations of downstream positions (also referred to as downstream locations) according to a pattern known by both a transmitter and a receiver. An advantage of this embodiment is that it can improve demodulation decisions made by receivers that are in environments where downstream artifacts unacceptably corrupt demodulation decisions. More specifically, an advantage of this embodiment is that integration results (e.g., outputs 1624, 1625, 1644 and 1645 of accumulators 1620, 1621, 1640 and 1641, respectively) generated by a receiver (e.g., receiver 1602 of FIG. 16) are less susceptible to the effects of downstream artifacts. This is because the shifting of downstream locations breaks up the effects of downstream artifacts.

The downstream locations are shifted with respect to the first location. Of course all of the locations can be changing on a frame by frame basis due to coding, which is discussed above. The shifting that is referring to in this embodiment is shifting in addition to any moving of impulse positions due to coding.

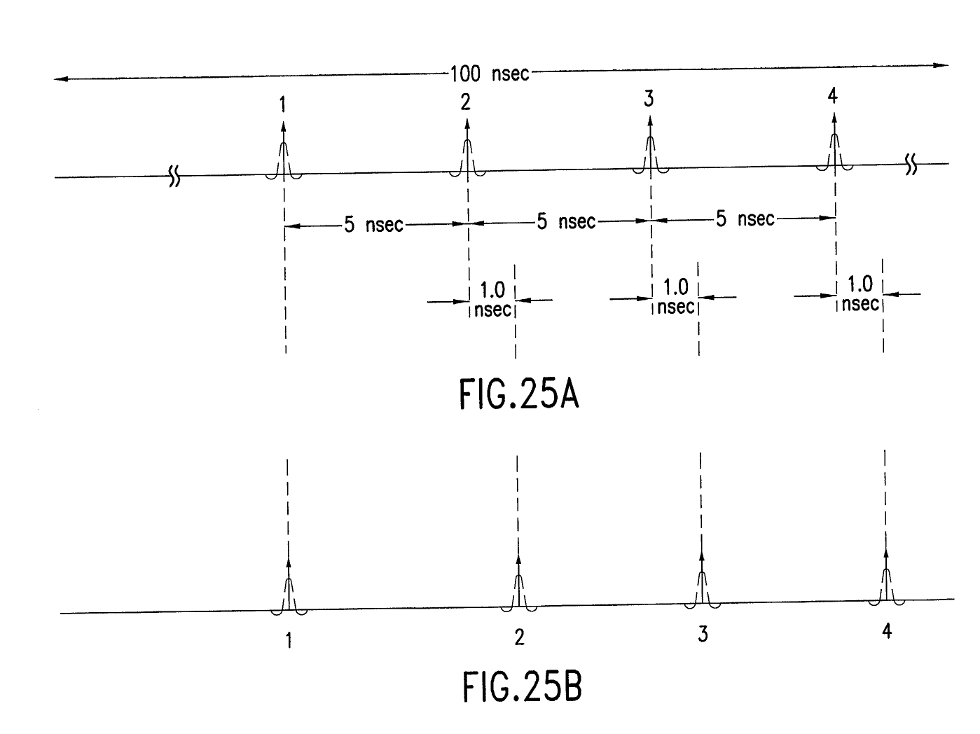

This embodiment of the present invention can be further explained with reference to FIGS. 25A and 25B. Referring first to FIG. 25A, during a first frame (e.g., a 100 nsec frame) each of the four possible positions of an impulse (represented by dashed lined impulses) is located at positions spaced 5.0 nsec apart from on another. Referring to FIG. 25B, during a second frame (e.g., a second 100 nsec frame) the second, third and fourth of the four possible positions of an impulse are each shifted by 1 nsec as compared to their original positions and with respect to the first position. Preferably, the shift is greater than the width of each impulse (for this example, greater than 0.5 nsec). During a third frame the second, third and fourth possible positions of an impulse can be the same as in FIG. 25A. Alternatively, each of the second, third and fourth positions can be shifted to yet another location. As the possible positions of the second third and fourth impulses are being shifted, the receiver is adjusting the locations within a frame where its second, third, and fourth correlators are sampling frames of a received signal. Referring to FIG. 16, this can be accomplished, for example, by appropriately adjusting delays 1679, 1677 and 1675.

IV. M-of-N Positions Modulation

In the above discussed embodiments of the present invention, an impulse is placed within one of a plurality of possible positions within each time frame of an impulse radio signal. For example, if two possible positions exist within a time frame, then each position can represent one of two data states (e.g., a 0 bit, or a 1 bit). If four possible positions exist within a time frame, then four data states can be represented (e.g., each position can represent two bits, i.e., 00, 01, 10, or 11). If eight possible positions exist within a time frame, then each position can represent one of eight data states (e.g., bits 000, 001, 010, 011, 100, 101, 110, or 111), and so on. Collectively, these embodiments have been referred to as “one-of-many” positions modulation or “one-of-N” positions modulation.

In an alternative embodiment of the present invention, impulses can be placed in more than one position within each time frame. For example, in a “two-of-four” positions modulation scheme, impulses can be placed in the first and second positions, in the first and third positions, in the first and fourth positions, in the second and third positions, in the second and fourth positions, or the third and fourth positions. Thus, in a “two-of-four” positions modulation scheme, five different data states can be represented. This is one additional data state than in the “one-of-four” positions modulations scheme discussed above. In a “two-of-eight” positions modulation scheme, 28 different data states can be represented. This is 20 additional data states than in the “one-of-eight” positions modulation scheme discussed above. Thus, an “M-of-N” positions modulation scheme, also referred to as an “M-of-many” positions modulation scheme can be used to significantly increase the data throughput of an impulse radio communications system.

V. One-of-Many Positions with Shift Modulation

In another embodiment of the present invention, in addition to placing each impulse at one-of-N widely separated positions within each time frame, each impulse can also be dithered by less than ½ the width of each impulse, thereby doubling the number of data states. For example, in a one-of-four positions with shift modulation scheme, where the width of impulses are approximately 0.5 nsec, each impulse can be placed in one of four possible widely separated positions or in one of four additional possible positions that are slightly offset (e.g., by 150 psec) from the four widely separated positions. Thus, a one-of-four positions with shift modulation scheme provides for eight data states.

VI. One-of-Many Positions with Flip Modulation

In another embodiment of the present invention, in addition to placing each impulse in one-of-N positions within each frame, each impulse can also be flipped (i.e., inverted), thereby doubling the number of data states. Thus, in a one-of-four positions with shift modulation scheme, a non-inverted impulse can be located in one of four possible positions or an inverted impulse can be located in one of the four possible postions, providing for eight data states. Flip modulation was described in U.S. patent application No. 09/537,629, filed Mar. 29, 2000, entitled “Apparatus, System and Method for Flip Modulation in an Impulse Radio Communications System,” which is incorporated herein by reference in its entirety.

VII. One-of-Many Positions with Amplitude Modulation

In another embodiment of the present invention, in addition to placing each impulse in one-of-N positions within each frame, the amplitude of each impulse can also be varied to create additional data states. For example, if each impulse can have one of two different amplitudes in a one-of-four positions modulation scheme, then eight data states exist. If each impulse can have one of three different amplitudes in a one-of-four positions modulation scheme, then twelve data states exist.

VIII. Combining Embodiments

The various embodiment of the present invention can be combined to further increase the number of different data states that can be represented in a frame, and thus to increase the data throughput in an impulse radio communications system. For example, M-of-N positions modulation can be combined with flip and/or amplitude modulation. In another example, one-of-N positions with shift modulation can be combined with flip modulation. These are just two examples of how the above discussed embodiments of the present invention can be combined. All of the various combinations are within the spirit and scope of the present invention.

IX. Conclusion

The present invention relates to the transmission and reception of signals that are modulated using what has been referred to as “one-of-many positions” modulation. For example, in one embodiment of the present invention, what has been referred to as “one-of-four-positions” modulation is used. In “one-of-four-positions” modulation, a first data state corresponds to an impulse located at a first position within a time frame, a second data state corresponds to an impulse located at a second position within the time frame, a third data state corresponds to an impulse located at a third position within the time frame, and a fourth data state corresponds to an impulse located at a fourth position within the time frame. Of course, the teachings of the present invention can be used to develop modulation schemes that include even more data states, while still being within the spirit and scope of the present invention. For example, the teachings of the present invention can be used to create modulations schemes with six, eight, or more different data states. Accordingly, the intention is for the present invention to encompass such additional modulation schemes and the apparatus, methods, and systems associated with them. Further, as discussed above, the present invention also includes the combination of one-of-many positions modulation with other modulation techniques, such as, flip and amplitude modulation.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

It is anticipated that many features of the present invention can be performed and/or controlled by a control processor, which in effect comprises a computer system. Such a computer system includes, for example, one or more processors that are connected to a communication bus. Although telecommunication-specific hardware can be used to implement the present invention, the following description of a general purpose type computer system is provided for completeness.

The computer system can also include a main memory, preferably a random access memory (RAM), and can also include a secondary memory. The secondary memory can include, for example, a hard disk drive and/or a removable storage drive. The removable storage drive reads from and/or writes to a removable storage unit in a well known manner. The removable storage unit, represents a floppy disk, magnetic tape, optical disk, and the like, which is read by and written to by the removable storage drive. The removable storage unit includes a computer usable storage medium having stored therein computer software and/or data.

The secondary memory can include other similar means for allowing computer programs or other instructions to be loaded into the computer system. Such means can include, for example, a removable storage unit and an interface. Examples of such can include a program cartridge and cartridge interface (such as that found in video game devices), a removable memory chip (such as an EPROM, or PROM) and associated socket, and other removable storage units and interfaces which allow software and data to be transferred from the removable storage unit to the computer system.

The computer system can also include a communications interface. The communications interface allows software and data to be transferred between the computer system and external devices. Examples of communications interfaces include, but are not limited to a modem, a network interface (such as an Ethernet card), a communications port, a PCMCIA slot and card, etc. Software and data transferred via the communications interface are in the form of signals that can be electronic, electromagnetic, optical or other signals capable of being received by the communications interface. These signals are provided to the communications interface via a channel that can be implemented using wire or cable, fiber optics, a phone line, a cellular phone link, an RF link, and the like.

In this document, the terms “computer program medium” and “computer usable medium” are used to generally refer to media such as removable storage device, a removable memory chip (such as an EPROM, or PROM) within a transceiver, and signals. Computer program products are means for providing software to the computer system.

Computer programs (also called computer control logic) are stored in the main memory and/or secondary memory. Computer programs can also be received via the communications interface. Such computer programs, when executed, enable the computer system to perform certain features of the present invention as discussed herein. In particular, the computer programs, when executed, enable a control processor to perform and/or cause the performance of features of the present invention. Accordingly, such computer programs represent controllers of the computer system of a transceiver.

In an embodiment where the invention is implemented using software, the software can be stored in a computer program product and loaded into the computer system using the removable storage drive, the memory chips or the communications interface. The control logic (software), when executed by a control processor, causes the control processor to perform certain functions of the invention as described herein.

In another embodiment, features of the invention are implemented primarily in hardware using, for example, hardware components such as application specific integrated circuits (ASICs). Implementation of the hardware state machine so as to perform the functions described herein will be apparent to persons skilled in the relevant art(s).

In yet another embodiment, features of the invention can be implemented using a combination of both hardware and software.

The previous description of the preferred embodiments is provided to enable any person skilled in the art to make or use the present invention. While the invention has been particularly shown and described with reference to preferred embodiments thereof, it will be understood by those skilled in the art that various changes in form and details may be made therein without departing from the spirit and scope of the invention.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A receiver for demodulating received impulse radio signals that are modulated according to a one-of-two positions modulation scheme, the receiver comprising:
an adjustable precision timing generator producing a first timing signal and a second timing signal separated in time from one another by more than ½ the width of impulses of the received impulse radio signal;
a first sampler triggered to sample the received impulse radio signal in accordance with said first timing signal and to provide a first sampler output;
a second sampler triggered to sample the received impulse radio signal in accordance with said second timing signal and to provide a second sampler output; and
a data detector to produce a demodulation decision based on the first sampler output and the second sampler output.

2. The receiver of claim 1, wherein the received impulse radio signal includes an impulse that is located in one of a first possible position and a second possible position within a time frame of the received impulse radio signal.

3. The receiver of claim 2, wherein said first timing signal corresponds to said first possible position and said second timing signal corresponds to said second possible position.

4. The receiver of claim 3, wherein said first possible position is separated from said second possible position by a distance that is at least 10 times the width of impulses of the received impulse radio signal, and wherein said first timing signal and said second timing signal are separated in time by said distance.

5. The receiver of claim 4, wherein the width of the impulses of the received impulse radio signal are approximately 0.5 nsec and said distance is at least 5.0 nsec.

6. A method for demodulating received impulse radio signals that are modulated according to a one-of-two positions modulation scheme, comprising the steps of:
producing a first timing signal and a second timing signal separated in time from one another by more than ½ the width of impulses of the received impulse radio signal;
sampling the received impulse radio signal in accordance with said first timing signal to provide a first sampler output;
sampling the received impulse radio signal in accordance with said second timing signal to provide a second sampler output; and
producing a demodulation decision based on the first sampler output and the second sampler output.

7. The method of claim 6, wherein the received impulse radio signal includes an impulse that is located in one of a first possible position and a second possible position within a time frame of the received impulse radio signal.

8. The method of claim 7, wherein said first timing signal output corresponds to said first possible position and said second timing signal output corresponds to said second possible position.

9. The method of claim 8, wherein said first possible position is separated from said second possible position by a distance that is at least 10 times the width of impulses of the received impulse radio signal, and wherein said first timing signal and said second timing signal are separated in time by said distance.

10. The method of claim 9, wherein the width of the impulses of the received impulse radio signal are approximately 0.5 nsec and said distance is at least 5.0 nsec.

11. A receiver for demodulating a received impulse radio signal that is modulated according to a one-of-N positions modulation scheme, where N is the number of different possible positions where an impulse can be located within each time frame of the impulse radio signal, the receiver comprising:
a timing generator to generating N timing signals per each time frame of the received impulse radio signal, wherein each of said N timing signals is separated in time by more than ½ the width of impulses of the received impulse radio signal;
one or more samplers triggered to sample the received impulse radio signal in accordance with said N timing signals and to provide a first to Nth sampler outputs; and
a data detector to produce a demodulation decisions based on said first to Nth sampler outputs.

12. The receiver of claim 11, wherein the received impulse radio signal includes impulses that are located in one of a first to Nth possible positions within a time frame of the received impulse radio signal.

13. The receiver of claim 12, wherein said first to Nth timing signals corresponds said first to said first to Nth possible positions, respectively.

14. The receiver of claim 13, wherein each of the N possible positions are separated from one another by at least 10 times the width of impulses of the received impulse radio signal, and wherein said first to Nth timing signal are separated in time by the same distances that said first to Nth possible positions are separated.

15. The receiver of claim 14, wherein the width of the impulses of the received impulse radio signal are approximately 0.5 nsec, and wherein each of the N possible positions are separated from one another by at least 5.0 nsec.

16. A method for demodulating a received impulse radio signal that is modulated according to a one-of-N positions modulation scheme, where N is the number of different possible positions where an impulse can be located within each time frame of the impulse radio signal, comprising the steps of:
producing N timing signals per each time frame of the received impulse radio signal, wherein each of said N timing signals is separated in time by more than ½ the width of received impulses of the received impulse radio signal;
sampling the received impulse radio signal in accordance with said N timing outputs and to provide a first to Nth sampler outputs; and
producing a demodulation decisions based on the first to Nth sampler outputs.

17. The method of claim 16, wherein the received impulse radio signal includes an impulse that is located in one of a first to Nth possible positions within a time frame of the received impulse radio signal.

18. The method of claim 17, wherein said first to Nth timing signals corresponds said first to an Nth possible positions, respectively.

19. The method of claim 18, wherein each of the N possible positions are separated from one another by at least 10 times the width of the impulses of the received impulse radio signal, and wherein said first to Nth timing signal are separated in time by the same distances that said first to Nth possible positions are separated.

20. The method of claim 19, wherein the width of the impulses of the received impulse radio signal are approximately 0.5 nsec, and wherein each of the N possible positions are separated from one another by at least 5.0 nsec.

21. A receiver for processing a received impulse radio signal that is modulated according to a one-of-N positions modulation scheme, where N is the number of different positions where an impulse can be located within each time frame of the impulse radio signal, the receiver comprising:
an adjustable precision timing generator to produce N timing signals per time frame of the received impulse radio signal, wherein each of said N timing signals is separated in time from one another by more than ½ the width of impulses of the received impulse radio signal;
a data correlator to sample the received impulse radio signal in accordance with said N timing signals and to provide a first sampler output through an Nth sampler output;
a threshold comparitor to compare each of said first sampler output through said Nth sampler output to a threshold, and to output a threshold trigger signal when said threshold is exceeded;
a data sample and hold (S/H) to sample at least one of said first sampler output through said Nth sampler output in response to said threshold trigger signal, and to output at least one corresponding sample value that exceeds said threshold;
a counter to increment a count value in response to receiving each of said N timing outputs, and to reset every N timing outputs;
a latch to store said count value in response to said threshold trigger signal; and
a data detector to produce a demodulation decision based on at least said count value received from said latch and said corresponding sample value.

22. The receiver of claim 21, wherein the received impulse radio signal includes an impulse that is located in one of a first to Nth possible positions within a time frame of the received impulse radio signal.

23. The receiver of claim 22, wherein said first to Nth timing signals corresponds said first to Nth possible positions, respectively.

24. The receiver of claim 23, wherein each of the N possible positions are separated from one another by at least 10 times the width of impulses of the received impulse radio signal, and wherein said first to Nth timing signal are separated in time by the same distances that said first to Nth possible positions are separated.

25. The receiver of claim 24, wherein the width of the impulses of the received impulse radio signal are approximately 0.5 nsec, and wherein each of the N possible positions are separated from one another by at least 5.0 nsec.

26. A method for processing a received impulse radio signal that is modulated according to a one-of-N positions modulation scheme, where N is the number of different positions where an impulse can be located within each time frame of the impulse radio signal, comprising the steps of:
sampling the received impulse radio signal at each of N possible positions where an impulse can be located within each time frame of the received impulse radio signal to produce a first sampler output through an Nth sampler output;
comparing each of said first sampler output through said Nth sampler output to a threshold;
producing a threshold trigger signal whenever said threshold is exceeded;
sampling at least one of said first sampler output through said Nth sampler output in response to said threshold trigger signal to produce at least one corresponding sample value that exceeds said threshold;
incrementing a count value in response to receiving each of said N timing outputs, wherein said count value is reset every N timing outputs;
storing said count value in response to said threshold trigger signal; and
producing a demodulation decision based on at least said count value and said corresponding sample value.

27. The method of claim 26, wherein the received impulse radio signal includes an impulse that is located in one of a first to Nth possible positions.

28. The method of claim 27, wherein each of the N possible positions are separated from one another by at least 10 times the width of impulses of the received impulse radio signal.

29. The method of claim 28, wherein the width of impulses of the received impulse radio signal are approximately 0.5 nsec, and wherein each of the N possible positions are separated from one another by at least 5.0 nsec.

30. The method of claim 26, wherein the width of impulses of the received impulse radio signal are approximately 0.5 nsec, and wherein each of the N possible positions are separated from one another by at least 5.0 nsec.

31. A method for making demodulation decisions based on a received impulse radio signal that has been modulated according to a one-of-N positions modulation scheme, where N is the number of possible positions where an impulse can be located within each time frame of the impulse radio signal, comprising the steps of:
a. receiving a plurality of training frames of an impulse radio signal wherein the position of a n impulse within each frame is known;
b. sampling each training frame at the position within each time frame where the impulse is known to be located to produce training impulse samples;
c. sampling each position within each training frame that is later in time than the position where the impulse is known to be located to produce training downstream samples;
e. receiving additional frames of an impulse radio signal; and
f. producing a demodulation decision based on said additional frames and said training downstream samples.

32. The method of claim 31, wherein step f. comprises the steps of:
i. sampling each of the additional frames at each of the possible N positions where an impulse can be located to produce data samples; and
ii. producing the demodulation decision based on at least said data samples and said training downstream samples.

33. The method of claim 32, wherein step f.ii. comprises producing the demodulation decisions based also on the training impulse samples.

34. The method of claim 33, wherein step a. comprises receiving X frames where the impulse is located in a first of the N positions, X frames wherein the impulse is located in a second of the N positions . . . and X frames where the impulse is located in the Nth-1 position of the N positions.

35. The method of claim 34, wherein step b. comprises producing the training impulse sample values by
sampling the first position in the X frames where the position of the impulse is located at the first position,
sampling the second position in the X frames where the position of the impulse is located at the second position, . . . and
sampling the Nth-1 position in the X frames wherein the position of the impulse is located at the Nth-1 position.

36. The method of claim 35, wherein step c. comprises producing the downstream samples by
sampling the second through Nth positions in the X frames where the impulse is located at the first position,
sampling the third through Nth positions in the X frames where the impulse is located at the second position, . . . and
sampling the Nth position in the X frames where the impulse is located at the Nth-1 position.
